(19) United States
(12) Patent Application Publication
(10) Pub. No.: US 2026/0350631 A1
(43) Pub. Date: Nov. 5, 2026

(54) Governed Memory-Use Control System for Regulated Computing and Artificial Intelligence Environments

(71) Applicant: OneSource Solutions International, Inc., Sudbury, MA (US)

(72) Inventors: Harold Arkoff, Sudbury, MA (US); Vedran Jukic, Trieste (IT)

(73) Assignee: OneSource Solutions International, Inc., Sudbury, MA (US)

(21) Appl. No.: 19/661,444

(22) Filed: Apr. 28, 2026

Related U.S. Application Data
(60) Provisional application No. 63/799,440, filed on May 3, 2025.

(51) Int. Cl. G06Q 30/018; G06F 21/16

(52) U.S. Cl. CPC G06Q 30/018; G06F 21/16; G06F 2221/2101

(57) ABSTRACT

A governed memory-use control system controls use of stored data, including semantic memory assets, in regulated computing environments. The system forms governed memory assets from protected source records, each asset including semantic representations, provenance linkage, governance metadata, authorization metadata, and version-state data. In response to a memory-use request, the system identifies candidate memory assets and evaluates machine-readable decision conditions, including semantic-support, provenance-validation, authorization, and memory-validity conditions. A response policy selects and enforces a response mode before a candidate asset is permitted to influence a requested operation, including retrieval, output generation, writing, disclosure, export, artifact generation, corpus formation, or localized model-package generation. The system records structured decision-basis records in a tamper-evident audit structure. Derived artifacts and deployment artifacts preserve lineage and governance continuity, and execution contexts may be verified using isolation policies.

### CROSS-REFERENCE TO RELATED APPLICATIONS

This application claims the benefit of and priority to U.S. Provisional Patent Application No. 63/799,440, filed on May 3, 2025, and titled “Semantic Memory Governance System for Regulated AI.” The entire disclosure of the foregoing application is hereby incorporated by reference in its entirety for all purposes, to the extent permitted by law and not inconsistent with the present disclosure.

### FIELD OF THE INVENTION

The present invention relates generally to computer-implemented systems and methods for controlling use of stored data in computing environments.

More particularly, the invention pertains to systems and methods for forming, storing, evaluating, and controlling use of governed memory assets through machine-readable governance state, decision-condition evaluation, response-mode enforcement, and audit traceability within regulated computing environments.

In particular embodiments, the invention relates to semantic memory governance for regulated artificial intelligence systems in which semantic memory assets, semantic retrieval operations, generated outputs, agent-associated memory, governed downstream artifacts, retrieval bindings, deployment artifacts, and localized model-package generation workflows are governed through machine-readable decision conditions, response-mode enforcement, lineage preservation, and audit traceability.

Although particularly useful for semantic memory governance in regulated artificial intelligence systems, the disclosed decision-condition framework may also be applied in other regulated computing environments involving controlled use of governed memory assets under provenance, authorization, lifecycle, policy, response-mode, lineage, audit, and execution-context constraints.

### BACKGROUND OF THE INVENTION

Computing systems increasingly rely on stored data and derived representations to support retrieval, decision-making, automated processing, and generation of outputs. In many implementations, data is ingested from multiple sources, transformed into searchable representations or searchable memory indexes, and later accessed through query mechanisms or used to produce derived outputs. Conventional architectures typically treat stored data as passively retrievable content, where access is governed primarily by coarse-grained access controls, such as user authentication or role-based permissions, and where retrieval decisions are driven largely by relevance measures, such as keyword matching or similarity scoring.

These shortcomings are particularly acute in regulated artificial intelligence systems that rely on semantic memory, retrieval-augmented generation, agent-associated memory, or downstream model formation. In such systems, semantically relevant memory may influence generated outputs, workflow decisions, automated updates, governed downstream artifacts, or localized model packages even when that memory lacks acceptable provenance, exceeds authorization scope, is stale or superseded, is policy-ineligible, or is processed in a non-compliant execution context.

In regulated computing environments, including regulated artificial intelligence environments, the use of stored data is subject to additional requirements beyond relevance. Such environments may impose constraints relating to provenance, authorization, lifecycle state, policy compliance, privacy, security, auditability, export, disclosure, and operational context. For example, certain data may be restricted based on its origin, may require validation of lineage before use, may be subject to temporal validity constraints, or may require that access, disclosure, export, transformation, writing, packaging, or deployment be limited based on the purpose of use or execution environment. Conventional data storage and retrieval systems generally do not incorporate these factors into a unified, machine-enforced framework governing actual data use.

Existing systems that employ semantic representations or similarity-based retrieval mechanisms typically focus on identifying relevant data but do not ensure that identified data is eligible for use under applicable constraints. In many such systems, once data is identified or retrieved based on relevance, it may be used to generate outputs, update system state, or create downstream artifacts without verification of provenance, without validation of lifecycle state, and without enforcement of fine-grained policy conditions. As a result, data that is outdated, unauthorized, improperly sourced, non-provenance-validated, or otherwise restricted may inadvertently influence system outputs or derived artifacts.

Furthermore, conventional approaches to access control are often applied at the point of retrieval rather than at the point of use. These approaches may permit retrieval of data that is subsequently used in unintended ways, or may fail to account for differences between viewing data, transforming data, generating outputs from data, disclosing data, exporting data, writing data to memory, or incorporating data into derived artifacts, corpus snapshots, retrieval bindings, deployment artifacts, or localized model packages. Existing systems also typically lack mechanisms to differentiate between varying degrees of permissible use, such as returning full content, returning redacted content, limiting output to metadata, limiting output to provenance-supported content, preventing writing, controlling export or disclosure, or suppressing output entirely based on evaluated conditions.

Another limitation of conventional systems is the absence of structured, machine-readable records that capture the basis for data-use decisions. While some systems log access events, such logs often do not include sufficient information to reconstruct why a particular piece of data was used, why another was excluded, why export or disclosure was prevented, or how policy conditions influenced the outcome. This lack of decision traceability can impede auditing, compliance verification, incident investigation, and reconstruction of system behavior.

In addition, when data is transformed into derived artifacts or governed downstream artifacts, such as summaries, aggregated datasets, evaluation corpora, frozen corpus snapshots, retrieval bindings, deployment artifacts, or localized model packages, existing systems often fail to maintain linkage between the artifacts and the underlying source data. As a result, governance constraints associated with the original data may not propagate to downstream artifacts, allowing restricted or invalid data to influence subsequent operations outside the original control context.

Conventional systems also provide limited mechanisms for ensuring that data-use operations occur within compliant computational environments. Data may be processed in shared or non-isolated execution contexts without verification that such environments satisfy required isolation, security, or policy constraints. This can introduce risks related to unintended data exposure, cross-domain contamination, unauthorized co-residency, downstream disclosure, export, or violation of execution policies.

As a result, conventional systems may permit unauthorized disclosure, unintended propagation, or downstream exfiltration of sensitive data, governed memory assets, derived artifacts, or governed downstream artifacts once such data has been identified, retrieved, transformed, packaged, or deployed.

In regulated artificial intelligence systems, semantically relevant memory is not necessarily eligible memory. A memory asset may be relevant to a request yet still be unsuitable for use because it lacks acceptable provenance, exceeds authorization scope, is stale, superseded, policy-ineligible, or assigned to a non-compliant execution context. The disclosed invention addresses this problem by converting memory use into a governed, auditable, machine-enforced decision process that makes semantic memory operationally usable in regulated artificial intelligence environments.

Accordingly, there exists a need for a technical architecture that treats stored data not merely as retrievable content, but as governed memory assets whose use is conditioned on evaluation of multiple machine-readable factors. Such an architecture should enforce decision conditions prior to use, support multiple controlled response modes, maintain provenance and lifecycle awareness, preserve governance continuity into downstream artifacts, ensure execution within compliant contexts, and provide structured traceability records enabling reconstruction of system decisions and behavior.

The present invention addresses these and other technical challenges by providing a governed memory-use control system in which memory assets are formed with associated governance state, evaluated through machine-enforced decision conditions prior to use, subjected to controlled execution outcomes, and recorded through structured, tamper-evident traceability mechanisms.

### SUMMARY OF THE INVENTION

In various embodiments, the invention provides a governed memory-use control system for regulated computing environments, including regulated artificial intelligence environments. The system forms governed memory assets from protected source records by associating memory units with semantic representations, provenance linkage, governance metadata, authorization metadata, representation-version metadata, and version-state data. The governed memory assets are stored in a governed memory store and may be indexed by a searchable memory index. The governed memory assets are not permitted to affect retrieval, output generation, memory updates, disclosure, export, derived-artifact generation, corpus formation, retrieval-binding generation, deployment-artifact generation, or localized model-package generation unless applicable machine-readable decision conditions are satisfied.

In certain embodiments, the governed memory-use control system is implemented as a semantic memory governance architecture for regulated artificial intelligence systems. In such embodiments, semantic memory assets are formed from protected source records, stored with machine-readable governance state, and prevented from influencing AI retrieval, output generation, agent-associated memory updates, corpus formation, retrieval bindings, deployment artifacts, or localized model-package generation unless applicable decision conditions are satisfied.

In certain embodiments, the disclosed invention operates as a pre-use decision-and-enforcement layer for governed memory. Candidate memory identified by search, retrieval, ranking, semantic similarity, metadata filtering, or other selection is not permitted to influence a requested operation merely because it has been identified as potentially relevant. Instead, identification of a candidate governed memory asset is separated from authorization to use that asset.

In one embodiment, the system receives a memory-use request from a requesting actor, generates or receives a request representation, and identifies one or more candidate governed memory assets using a searchable memory index. The system evaluates, for at least one candidate governed memory asset, a memory-use decision condition comprising a semantic-support condition, a provenance-validation condition, an authorization condition, and a memory-validity condition. Additional conditions may include confidence, ambiguity, citation, policy conflict, tenant boundary, risk, or isolation conditions.

In representative implementations, the system performs the foregoing control by generating request representations, identifying candidate governed memory assets through a searchable memory index, evaluating ordered or combined machine-readable decision conditions, mapping decision outcomes to enforceable response modes, and recording decision-basis information in a tamper-evident audit structure before governed memory is permitted to influence a requested operation.

The disclosed architecture is distinct from conventional storage, retrieval, and access-control systems because it combines governed memory asset formation, separation of candidate identification from authorization to use, multi-condition pre-use evaluation, staged response-mode enforcement, governance continuity into downstream artifacts, and optional execution-context verification into a unified machine-enforced control framework.

In further embodiments, the evaluated decision conditions function as truthfulness and eligibility constraints for AI-driven retrieval and output generation by preventing unsupported, non-provenance-validated, unauthorized, stale, superseded, improperly isolated, or policy-ineligible governed memory assets from influencing generated outputs, summaries, agent actions, memory updates, or downstream artifacts.

In further embodiments, the system selects a response mode according to a response policy based on the evaluated decision conditions. The response mode may permit execution, limit execution, return plaintext content, return protected content, return redacted content, return metadata-only information, return summary-only or citation-limited output, generate a derived output, suppress output, deny the operation, prevent memory writing, control export, control disclosure, delay release pending secondary approval, or route the request for review. The selected response mode is enforced before the governed memory asset is allowed to affect the requested operation.

In further embodiments, the system generates structured decision-basis records and audit event records corresponding to memory formation, memory-use requests, decision-condition evaluation, response-mode selection, execution control, derived-artifact generation, isolation verification, corpus formation, retrieval-binding generation, deployment-artifact generation, and localized model-package generation. The records may be stored in a tamper-evident audit structure to enable reconstruction of why a governed memory asset was permitted, limited, suppressed, denied, routed for review, prevented from writing, prevented from export or disclosure, or otherwise controlled.

In further embodiments, derived artifacts and governed downstream artifacts generated from governed memory assets inherit or are associated with provenance linkage, governance metadata, version-state data, lineage information, and audit linkage. Such artifacts may include summaries, transformed records, redacted records, evaluation records, retrieval bindings, corpus items, frozen corpus snapshots, deployment artifacts, localized model packages, or other data objects. A derived artifact or governed downstream artifact written to the governed memory store may itself be treated as a governed memory asset subject to later memory-use decision evaluation.

In further embodiments, the system controls memory associated with requesting actors and computational actors, including episodic memory segments or episodic memory shards. Actor-associated memory operations, including creation, update, retrieval, freezing, retirement, tombstoning, or archival, may be evaluated as memory-use operations and enforced through the same decision-condition and response-policy framework.

In further embodiments, the system verifies execution contexts assigned to memory-use operations. The system may generate a resource fingerprint, compare the resource fingerprint against an isolation policy, record an isolation-verification event, and deny, suppress, reassign, limit, prevent writing, or route an operation for review when the execution context fails to satisfy the isolation policy.

In further embodiments, the system forms governed downstream artifacts from governed memory assets. The governed downstream artifacts may include frozen corpus snapshots, evaluation corpora, retrieval bindings, deployment artifacts, and localized model packages. Formation of such artifacts is treated as a governed memory-use operation, preserving provenance linkage, governance metadata, version-state data, lineage information, and audit traceability across downstream artifacts.

In practical operation, the disclosed architecture protects the control layer that determines whether governed memory may influence retrieval, generated outputs, actor-associated memory operations, derived artifacts, corpus states, retrieval bindings, deployment artifacts, and localized model packages, rather than merely protecting storage or access to underlying source data.

Accordingly, the disclosed architecture provides a technical control framework in which governed memory assets are formed with machine-readable governance state, evaluated before use, subjected to enforceable response modes, and recorded through structured traceability records. This improves regulated computing systems by preventing unauthorized, unsupported, stale, non-provenance-validated, improperly isolated, or policy-ineligible memory from influencing outputs, memory updates, derived artifacts, corpus snapshots, retrieval bindings, deployment artifacts, or localized model packages.

The disclosed architecture further reduces risk of unauthorized access, disclosure, or exfiltration by preventing protected source records, governed memory assets, derived artifacts, and governed downstream artifacts from being returned, exported, disclosed, transformed, written, packaged, deployed, reused, or processed unless applicable semantic-support, provenance, authorization, validity, response-policy, and execution-context conditions are satisfied.

### BRIEF DESCRIPTION OF THE DRAWINGS

FIG. 1 illustrates a governed memory-use control architecture for a regulated artificial intelligence environment, including governed memory formation, candidate memory identification, memory-use decision evaluation, response-mode enforcement, audit traceability, actor-associated memory lifecycle control, execution-context verification, and governed downstream artifact control.

FIG. 2 illustrates a governed memory formation flow in which a protected source record is processed into one or more memory units and corresponding governed memory asset records comprising semantic representation data, provenance linkage, governance metadata, authorization metadata, representation-version metadata, and version-state data.

FIG. 3 illustrates a governed memory-use decision flow in which a memory-use request leads to request representation generation, candidate governed memory asset identification, and evaluation of semantic-support, provenance-validation, authorization, and memory-validity conditions before a candidate governed memory asset is permitted to influence a requested operation.

FIG. 4 illustrates response-mode selection, response-mode enforcement, and audit traceability for a memory-use request, including enforcement of a selected response mode before a candidate governed memory asset is permitted to affect the requested operation and recording of a structured decision-basis record in a tamper-evident audit structure.

FIG. 5 illustrates governed downstream artifact generation and lineage control in which one or more governed memory assets are used, subject to decision-condition evaluation and response-mode enforcement, to generate a governed downstream artifact associated with lineage information, governance state, version-state data, and audit linkage.

FIG. 6 illustrates execution-context verification and governed formation of downstream artifacts, including frozen corpus snapshots, evaluation corpora, retrieval bindings, deployment artifacts, localized model packages, lineage association, and cleanup recording.

FIG. 7 illustrates actor-associated memory lifecycle governance in which episodic memory segments or episodic memory shards are created, updated, retrieved, frozen, retired, tombstoned, archived, or otherwise controlled under the same memory-use decision-condition and response-policy framework.

### DETAILED DESCRIPTION OF THE INVENTION

### Definitions

The following terms are provided to clarify the disclosed embodiments and claimed subject matter. Unless the surrounding context requires otherwise, the terms below include structural equivalents, functional equivalents, and later-developed technical implementations consistent with the described architecture. The definitions are not intended to exclude additional examples described elsewhere in this specification.

“Governed memory-use control system” refers to a computing system configured to store memory assets with machine-readable governance state and to control use of those memory assets by evaluating decision conditions before permitting, limiting, suppressing, denying, or routing a requested operation.

“Regulated computing environment” denotes a computing environment in which memory-use operations are subject to policy, authorization, provenance, audit, security, privacy, compliance, or operational-control requirements.

“Computing node” means a physical, virtual, containerized, edge, cloud, on-premises, or distributed computing resource having processing capability and configured to execute one or more functions of the disclosed system.

“Organization-controlled execution environment” refers to an execution environment operated, configured, administered, restricted, or governed by or on behalf of an organization for performing memory formation, memory-use, evaluation, audit, artifact-generation, or deployment operations.

“Authenticated communication channel” means a communication path through which a source, actor, process, or system is verified before protected records, requests, instructions, or operational data are received or transmitted.

“Governed memory store” denotes one or more storage systems, indexes, databases, object stores, graph stores, vector stores, caches, archives, or combinations thereof configured to store governed memory asset records and associated governance state.

“Searchable memory index” refers to a data structure or access mechanism used to identify candidate governed memory assets based on a request representation, query, rule, metadata value, similarity measure, relevance measure, or other selection criterion.

“Memory-use decision engine” means processor-executed logic configured to evaluate one or more machine-readable decision conditions before a governed memory asset is used in a requested operation.

“Response policy and execution control subsystem” refers to processor-executed logic configured to select a response mode based on decision-condition results and to enforce the selected response mode by controlling execution of the requested operation.

“Audit subsystem” denotes processor-executed logic and associated storage configured to generate, store, preserve, retrieve, or verify audit event records, decision-basis records, or other traceability records.

“Actor memory lifecycle subsystem” refers to processor-executed logic configured to control creation, writing, updating, freezing, retiring, tombstoning, archiving, retrieval, or other lifecycle operations for memory associated with a requesting actor or computational actor.

“Execution-context and isolation-verification subsystem” means processor-executed logic configured to identify an execution context, generate or receive a resource fingerprint, evaluate an isolation policy, and record an isolation-verification event.

“Corpus and deployment artifact subsystem” refers to processor-executed logic configured to select governed memory assets and form corpus snapshots, evaluation corpora, retrieval bindings, deployment artifacts, localized model packages, or other deployment-related objects.

“Protected source record” means a data item, file, message, object, field, payload, event, signal-derived record, structured record, unstructured record, multimodal record, or other source item received by the system and eligible for transformation into governed memory.

“Ingestion metadata record” refers to a structured record generated in connection with receipt of a protected source record and including one or more values such as a source identifier, time value, tenant identifier, record type, validation result, policy state, or provenance linkage.

“Source identifier” means an identifier, address, reference, pointer, record key, system identifier, tenant identifier, origin value, or other value that identifies a source associated with a protected source record.

“Time value” denotes a timestamp, time interval, sequence value, version time, logical clock value, or other temporal indicator associated with an event, record, operation, state, or artifact.

“Ingestion event” refers to a recorded event corresponding to receipt, validation, rejection, quarantine, acceptance, processing, or registration of a protected source record.

“Provenance linkage” means a machine-readable association identifying at least one originating, intermediate, or prior source from which a governed memory asset, derived artifact, corpus snapshot, or deployment artifact is obtained or influenced, thereby enabling source validity or lineage verification.

“Memory unit” denotes a bounded portion, segment, field, chunk, message, event, object, data element, or other unit derived from or associated with a protected source record and processed for representation, storage, retrieval, evaluation, or governance control.

“Memory-unit identifier” refers to an identifier, pointer, index value, positional value, relational value, or other reference associated with a memory unit.

“Semantic representation” means a machine-generated representation of a memory unit, request, artifact, or other object that captures informational, contextual, relational, semantic, or similarity-relevant characteristics for comparison, search, ranking, retrieval, or evaluation.

“Representation-version metadata” denotes metadata identifying a version, configuration, model, algorithm, index, transformation, parameter set, or processing pipeline used to generate, organize, update, or evaluate a representation.

“Governed memory asset” means a data object subject to machine-enforced control within the system and associated with governance metadata, provenance linkage, authorization metadata, and version-state data such that use of the data object in a memory-use operation is conditioned on evaluation of one or more decision conditions.

“Governed memory asset record” refers to a stored record corresponding to a governed memory asset and including, or being associated with, representation data, governance metadata, provenance linkage, authorization metadata, version-state data, audit linkage, or other machine-readable values used for evaluation or enforcement.

“Governance metadata” denotes machine-readable data specifying restrictions, classifications, policy states, sensitivity values, lifecycle states, lineage states, tenant restrictions, purpose restrictions, or other conditions governing use of a governed memory asset.

“Compliance metadata” refers to governance metadata identifying a regulatory, legal, contractual, organizational, privacy, security, confidentiality, privilege, sensitivity, or policy classification applicable to a memory asset or related object.

“Policy metadata” means governance metadata identifying a rule, policy, condition, scope, version, restriction, exception, override, or enforcement parameter applicable to a memory asset or operation.

“Authorization metadata” denotes metadata associated with a governed memory asset and used to evaluate whether a requesting actor is permitted to access, retrieve, modify, transform, write, export, include, or otherwise use the governed memory asset.

“Version-state data” refers to data indicating a lifecycle state, version state, validity state, supersession state, restriction state, or operational eligibility state of a memory asset, derived artifact, corpus snapshot, or deployment artifact.

“Memory-validity status” means a state value indicating whether a memory asset or related object is eligible, conditionally eligible, restricted, superseded, excluded, archived, tombstoned, pending review, forensic-only, or otherwise ineligible for a particular memory-use operation.

“Requesting actor” refers to any entity that initiates, submits, causes, triggers, or is associated with a memory-use request, including a human user, computational actor, service process, workflow process, application component, model process, administrative process, deployment process, or other authenticated or identifiable entity.

“Human user” means a natural person interacting with the system directly or indirectly through an interface, application, service, or workflow.

“Computational actor” includes, without limitation, an autonomous computational process, semi-autonomous computational process, service process, workflow process, application component, model process, administrative process, deployment process, or other non-human computational entity.

“Actor-specific data” refers to data associated with a requesting actor and used in evaluating a memory-use request, including identity data, role data, attributes, credentials, tenant identifiers, purpose-of-use indicators, context data, risk indicators, authorization data, or policy state.

“Memory-use request” means a request, instruction, invocation, trigger, call, or other initiation of a memory-use operation involving one or more governed memory assets.

“Memory-use operation” refers to an operation involving a governed memory asset and includes, without limitation, retrieval, output generation, summarization, transformation, redaction, writing, updating, deletion, corpus formation, evaluation-data generation, retrieval-binding generation, deployment-artifact generation, localized model-package generation, derived-artifact generation, disclosure, export, or participation in a deployment process.

“Requested operation” denotes a specific memory-use operation identified or implied by a memory-use request.

“Request representation” refers to a machine-generated or received representation corresponding to a memory-use request.

“Candidate governed memory asset” means a governed memory asset identified as potentially relevant to a memory-use request prior to evaluation of decision conditions.

“Memory-use decision condition” denotes a machine-evaluable condition, or set of conditions, applied to determine whether a governed memory asset may be used in a memory-use operation and, if so, under what response mode.

“Semantic-support condition” refers to a condition determining whether a relationship between a request representation and a memory asset representation satisfies a defined similarity, distance, ranking, relevance, or threshold criterion.

“Semantic-support value” means a computed value, score, rank, distance, similarity, relevance measure, or comparable machine-readable value representing a relationship between a request representation and a representation associated with a governed memory asset.

“Provenance-validation condition” denotes a condition evaluating whether a governed memory asset maintains provenance linkage satisfying a defined policy, source-validity, lineage-validity, or auditability requirement.

“Authorization condition” refers to a condition determining whether authorization data associated with a requesting actor satisfies governance metadata, authorization metadata, or a policy rule associated with a governed memory asset or requested operation.

“Memory-validity condition” means a condition evaluating whether version-state data or memory-validity status of a governed memory asset permits the requested operation.

“Confidence condition” denotes a condition derived from one or more machine-generated metrics indicating whether support for a requested operation satisfies a defined reliability, sufficiency, consistency, or agreement criterion.

“Ambiguity condition” refers to a condition evaluating whether multiple candidate assets, scores, rankings, or policy outcomes prevent selection of a supported result under a defined criterion.

“Citation condition” means a condition requiring linkage between an output, response, artifact, or operation and one or more supporting governed memory assets.

“Policy conflict condition” denotes a condition indicating conflicting governance or policy states.

“Tenant boundary condition” refers to a condition enforcing separation across tenants or domains.

“Risk condition” means a condition evaluating behavioral, contextual, operational, policy, or security risk associated with a requesting actor, governed memory asset, or memory-use operation.

“Isolation condition” denotes a condition evaluating whether an execution context satisfies an isolation policy.

“Decision result” refers to a machine-readable outcome of evaluating one or more memory-use decision conditions.

“Response policy” means a set of machine-readable rules, mappings, logic, thresholds, policy states, or evaluation criteria used to select or enforce a response mode based on a decision result.

“Response mode” denotes a system-controlled execution outcome determining how a memory-use operation is performed, limited, suppressed, denied, or otherwise controlled. “Response mode” includes, without limitation, plaintext return, protected-content return, redacted return, metadata-only return, summary-only return, citation-limited return, derived-output return, output suppression, operation denial, memory-write prevention, delayed release after secondary approval, human-review routing, export control, disclosure control, or other controlled execution outcome.

“Decision-basis record” denotes a structured machine-readable record capturing a memory-use request, one or more evaluated decision conditions, a selected response mode, and information sufficient to reconstruct a basis for a system decision.

“Audit event record” refers to a recorded event associated with system activity, including ingestion, representation generation, policy evaluation, memory-use decision, response-mode selection, execution control, artifact generation, isolation verification, or deployment activity.

“Tamper-evident audit structure” means a storage structure, record organization, or integrity mechanism configured to prevent, resist, or detect unauthorized modification of stored records. “Tamper-evident audit structure” includes, without limitation, append-only event stores, hash-linked event chains, Merkle-linked structures, digitally signed record sets, write-once storage structures, externally anchored audit digests, immutable object stores, or other integrity-preserving storage mechanisms.

“Derived artifact” refers to a data object, record, representation, summary, transformation, corpus item, evaluation item, binding, package, or deployment object generated from, influenced by, or linked to one or more governed memory assets.

“Lineage information” denotes data identifying relationships between a derived artifact and source governed memory assets. “Lineage information” includes records, graphs, or other data structures representing relationships among governed memory assets and derived artifacts.

“Inherited governance metadata” denotes governance metadata assigned based on one or more source assets.

“Computed governance state” refers to governance metadata determined through policy evaluation across multiple source assets.

“Execution context” refers to a defined computational environment assigned to perform or support a memory-use operation, including one or more processes, containers, virtual machines, namespaces, processors, accelerators, memory regions, storage volumes, network paths, runtime identities, or time-bound assignments.

“Resource fingerprint” denotes a set of identifiers, attributes, measurements, digests, or telemetry values representing one or more resources or boundaries of an execution context.

“Isolation policy” means a set of rules defining acceptable execution contexts, resource assignments, separation requirements, sharing restrictions, cleanup requirements, or verification requirements for a memory-use operation.

“Isolation-verification event” refers to a recorded event indicating whether an execution context satisfies an isolation policy.

“Isolation violation condition” includes contamination conditions, unauthorized co-residency conditions, namespace violations, storage conflicts, or other execution-context violations.

“Cleanup operation” denotes an action performed to remove or isolate data after an operation.

“Cleanup-completion event” refers to a recorded event indicating completion of a cleanup operation.

“Frozen corpus snapshot” refers to a write-locked, immutable, versioned, or otherwise controlled collection of governed memory assets selected under defined conditions for evaluation, packaging, deployment, update, or reconstruction.

“Evaluation corpus” denotes a dataset used for testing or validation derived from governed memory assets.

“Retrieval binding” means configuration data associating a system component with a defined subset of governed memory assets.

“Deployment artifact” refers to a data object, configuration, binding, package, model-related object, evaluation object, policy object, or other machine-readable object used for deployment or operation in a target environment.

“Localized model package” denotes a deployable set of model parameters, adapter parameters, configuration data, retrieval bindings, policy data, evaluation data, or related components derived from or associated with governed memory.

“Asset inclusion list” means a record identifying governed memory assets included in a corpus or artifact. “Asset exclusion list” refers to a record identifying governed memory assets excluded from a corpus or artifact.

“Deployment package” denotes a collection of components prepared for execution in a target environment.

“Allowed-state indicator” refers to a machine-readable value associated with an actor-associated memory segment, shard, or governed memory asset and identifying which lifecycle operations are permitted for that object.

“Episodic memory segment” refers to actor-associated memory bounded by a task, session, workflow, time interval, domain, or actor identity. “Episodic memory shard” denotes a partitioned actor-associated memory structure containing or referencing one or more governed memory assets and governed by shard-specific metadata or policy state.

“Response-mode identifier” refers to an identifier associated with a selected response mode.

“Expected-output record” refers to evaluation data identifying an output, result, constraint, or comparison target used to assess a system operation or deployment artifact.

“Actor-associated memory” refers to memory associated with a requesting actor or computational actor and subject to governance metadata, policy rules, lifecycle controls, or audit traceability.

“Regulated artificial intelligence environment” refers to a regulated computing environment in which one or more artificial intelligence, machine-learning, model-based, retrieval-augmented, agentic, generative, or automated reasoning processes use stored data, semantic representations, governed memory assets, or derived artifacts to support retrieval, output generation, workflow execution, model packaging, evaluation, or deployment.

“Selected response mode” means the response mode chosen by the system according to a response policy based on one or more evaluated decision conditions.

“Enforcement action” refers to an action taken by the system to carry out a selected response mode, including permitting, limiting, suppressing, denying, redacting, preventing writing, controlling export or disclosure, reassigning execution, or routing for review.

“Export control” refers to a response mode or enforcement action that prevents, limits, conditions, records, or routes for review transfer of content, metadata, governed memory assets, derived artifacts, corpus data, deployment artifacts, or related information outside a defined system, tenant, organization, jurisdiction, execution environment, or policy boundary.

“Disclosure control” refers to a response mode or enforcement action that prevents, limits, redacts, conditions, records, or routes for review presentation, release, transmission, or exposure of protected content, governed memory assets, derived artifacts, or related information to a requesting actor, process, system, or external recipient.

“Identifier” refers to a label, pointer, key, index value, or other machine-readable value associated with an operation, asset, policy, transformation, snapshot, or system object.

“Policy identifier” refers to an identifier associated with a policy, rule set, response policy, governance rule, isolation policy, authorization rule, or version thereof.

“Response-policy identifier” refers to an identifier associated with a response policy used to select or enforce a response mode.

“Condition evaluation result” refers to a machine-readable result indicating whether a decision condition was satisfied, failed, partially satisfied, unavailable, overridden, or routed for review.

“Provenance-validation result” refers to a machine-readable result indicating whether a provenance-validation condition was satisfied, failed, partially satisfied, unavailable, overridden, or routed for review.

“Authorization result” refers to a machine-readable result indicating whether an authorization condition was satisfied, failed, partially satisfied, unavailable, overridden, or routed for review.

“Memory-validity result” refers to a machine-readable result indicating whether a memory-validity condition was satisfied, failed, partially satisfied, unavailable, overridden, or routed for review.

“Decision reason” refers to a machine-readable value identifying why a response mode, enforcement action, or routing decision was selected, including suppression, denial, export control, disclosure control, or review routing.

“Defined threshold” refers to a machine-readable threshold, cutoff, range, rule, parameter, policy value, or criterion used to evaluate a condition, including a semantic-support condition.

“Provenance-validity requirement” refers to a policy, rule, condition, source requirement, lineage requirement, auditability requirement, or machine-readable criterion used to determine whether provenance linkage is acceptable for a requested operation.

“Authorized source state” refers to a source, source record, ingestion event, prior governed memory asset, derived artifact, corpus snapshot, or other source-associated state that satisfies a defined provenance-validity requirement or policy condition.

“Downstream artifact-generation operation” refers to a memory-use operation that generates, forms, updates, packages, or configures a governed downstream artifact from or based on one or more governed memory assets.

“Governed downstream artifact” refers to a derived artifact, frozen corpus snapshot, evaluation corpus, retrieval binding, deployment artifact, localized model package, or other downstream object generated from or influenced by governed memory assets and associated with lineage information, governance metadata, version-state data, audit linkage, or decision-basis information.

“Source governed memory asset” refers to a governed memory asset from which, or based on which, a derived artifact or governed downstream artifact is generated, formed, influenced, or linked.

“Permitted lifecycle operation” refers to a lifecycle operation identified by an allowed-state indicator as permitted for an actor-associated memory object, episodic memory segment, episodic memory shard, governed memory asset, derived artifact, or related object under applicable governance state.

### System Architecture

The disclosed system architecture provides a computing framework configured to form, store, evaluate, and control use of governed memory assets within a regulated computing environment. The architecture is implemented using one or more computing nodes, each comprising one or more processors, one or more non-transitory memory devices storing executable instructions, one or more persistent storage systems, and one or more network interfaces. The architecture is arranged such that governed memory assets are not merely stored and retrieved, but are subjected to machine-enforced control prior to any use in a memory-use operation.

In certain embodiments, the architecture operates as a semantic memory governance framework for regulated artificial intelligence, in which governed memory assets include semantic memory assets used for retrieval-augmented generation, agent-associated memory operations, truthfulness-constrained response generation, and controlled formation of localized model packages or other downstream AI artifacts.

In one embodiment, the system comprises a governed memory store configured to persist governed memory asset records together with governance metadata, provenance linkage, authorization metadata, and version-state data. The governed memory store may be implemented using one or more storage technologies, including indexed storage, searchable memory indexes, or distributed storage structures, provided that the stored records remain accessible for evaluation by the memory-use decision engine.

The system further comprises a memory formation subsystem configured to transform protected source records into one or more memory units and corresponding semantic representations. These representations are generated within an organization-controlled execution environment and are stored in association with the governed memory asset records. The architecture ensures that representations used for retrieval or comparison are consistent with representations used during ingestion, thereby enabling deterministic or policy-bounded evaluation of semantic-support conditions.

A memory-use decision engine is operatively coupled to the governed memory store and the searchable memory index. The memory-use decision engine is configured to receive a memory-use request, generate or receive a request representation, identify candidate governed memory assets, and evaluate one or more memory-use decision conditions. These conditions include at least a semantic-support condition, a provenance-validation condition, an authorization condition, and a memory-validity condition, and may further include additional conditions such as isolation conditions, risk conditions, or policy conflict conditions. The decision engine operates prior to execution of the requested operation and produces a decision result that determines whether and how the requested operation may proceed.

A response policy and execution control subsystem is configured to receive the decision result and select a response mode according to one or more policy rules. The subsystem enforces the selected response mode by controlling execution of the requested operation. Execution control may include permitting retrieval, restricting output, redacting content, suppressing output, denying the operation, preventing memory writing, or routing the request for further review. The architecture therefore separates identification of candidate memory assets from authorization of their use and from execution of the resulting operation.

An audit subsystem is coupled to each operational component of the system and is configured to generate audit event records and decision-basis records corresponding to ingestion events, representation generation, memory-use requests, evaluation of decision conditions, response-mode selection, execution outcomes, artifact generation, and isolation-verification events. The audit subsystem stores such records in a tamper-evident audit structure such that each memory-use operation can be reconstructed with respect to the requesting actor, evaluated conditions, selected response mode, and resulting action.

An actor memory lifecycle subsystem is configured to manage memory associated with requesting actors and computational actors. This subsystem controls creation, update, versioning, freezing, and restriction of memory segments or shards associated with actor activity, ensuring that memory written or accessed by an actor remains subject to the same governance and decision-condition enforcement as other governed memory assets.

An execution-context and isolation-verification subsystem is configured to determine whether a memory-use operation is performed within a compliant execution context. The subsystem identifies an execution context, generates a resource fingerprint, evaluates the resource fingerprint against an isolation policy, and produces an isolation-verification event. The result of this evaluation may be incorporated into the memory-use decision condition or enforced at execution time to prevent use of governed memory assets in non-compliant computational environments.

A corpus and deployment artifact subsystem is configured to generate higher-order data structures from governed memory assets, including frozen corpus snapshots, evaluation corpora, retrieval bindings, deployment artifacts, and localized model packages. This subsystem operates under the same decision-condition framework as other memory-use operations, ensuring that downstream artifacts maintain governance continuity and traceability to originating memory assets.

By enforcing decision-condition evaluation and response-mode control prior to any memory-use operation, the architecture prevents governed memory assets and derived artifacts from being accessed, disclosed, exported, or processed in a manner inconsistent with defined governance state, thereby reducing risk of unauthorized data exposure or exfiltration.

The system architecture is therefore arranged as an integrated set of subsystems in which governed memory formation, evaluation, controlled execution, audit traceability, actor-based control, isolation verification, and artifact generation are performed under a unified decision-condition framework. This arrangement provides a technical mechanism for ensuring that use of stored memory is conditioned not only on relevance, but also on provenance, authorization, lifecycle state, and execution context, thereby enabling controlled and auditable operation in regulated computing environments.

In this manner, the architecture functions as a machine-enforced control layer that determines whether memory may influence regulated AI behavior before such memory is permitted to affect an operation.

Unified Decision-Condition Framework for Governed Memory Use

In certain embodiments, the disclosed architecture applies a unified decision-condition framework to governed memory use. Under this framework, identification of a semantically relevant or otherwise candidate governed memory asset does not itself authorize use of that asset in a requested operation. Instead, prior to use, the system evaluates one or more machine-readable decision conditions to determine whether the asset may influence retrieval, output generation, agent-associated memory activity, derived-artifact generation, corpus formation, retrieval-binding generation, localized model-package generation, or another governed memory-use operation.

In one embodiment, the decision conditions comprise at least a semantic-support condition, a provenance-validation condition, an authorization condition, and a memory-validity condition. In further embodiments, the system may also evaluate one or more additional conditions, including a confidence condition, an ambiguity condition, a citation condition, a tenant-boundary condition, a risk condition, or an isolation condition. A failure of any required condition may result in limitation, suppression, denial, write prevention, review routing, or another controlled response mode rather than unrestricted use of the candidate governed memory asset.

In this manner, the architecture governs use of memory rather than merely access to memory. The same decision-condition framework may be applied across semantic retrieval, AI-driven response generation, actor-associated memory lifecycle operations, governed derived-artifact creation, frozen corpus snapshot formation, and localized model-package generation, thereby preserving provenance, compliance, authorization, lifecycle awareness, and audit traceability across the full memory-use lifecycle.

### Governed Memory Formation

The system is configured to transform protected source records into governed memory assets through a controlled formation process that associates each resulting memory unit with machine-readable governance state, provenance linkage, authorization metadata, and version-state data. This process establishes the structural and control characteristics that distinguish governed memory from conventional stored data.

In semantic-memory embodiments, the resulting governed memory assets function as semantic memory assets whose later retrieval and use in AI-driven operations are conditioned on the decision framework described herein.

In one embodiment, the system receives a protected source record through an authenticated communication channel and generates an ingestion metadata record comprising at least a source identifier and a time value. The system may further validate, normalize, classify, or otherwise process the protected source record according to one or more policy rules prior to formation of governed memory.

The protected source record is processed into one or more memory units. The formation of memory units may include segmentation, partitioning, extraction, structuring, normalization, or transformation of the protected source record. Each memory unit is associated with a memory-unit identifier and retains linkage to the protected source record through provenance linkage.

The system generates one or more semantic representations corresponding to the memory units. The semantic representations are generated within an organization-controlled execution environment and may be used for identification, comparison, ranking, or evaluation of candidate governed memory assets in response to a memory-use request. Representation-version metadata is associated with each generated representation to enable traceability of the generation process.

For each memory unit, the system creates a governed memory asset record. The governed memory asset record includes or is associated with the semantic representation, provenance linkage, governance metadata, authorization metadata, and version-state data. Governance metadata may include compliance metadata, policy metadata, sensitivity classifications, or other machine-readable restrictions governing use of the memory asset. Authorization metadata enables evaluation of whether a requesting actor is permitted to use the memory asset. Version-state data indicates a lifecycle state or memory-validity status of the memory asset.

The governed memory asset records are stored in the governed memory store in association with a searchable memory index. The storage process ensures that each governed memory asset remains accessible for evaluation by the memory-use decision engine and retains its associated governance and provenance information.

In some embodiments, the system may update, reprocess, or re-represent governed memory assets when representation models, governance policies, or source records change. In such cases, new representation-version metadata and version-state data are generated, and prior versions may be retained, superseded, restricted, or archived while preserving provenance linkage and audit traceability.

The governed memory formation process therefore ensures that each memory asset is created with sufficient structure and metadata to enable subsequent evaluation under the memory-use decision framework. By embedding governance state, provenance linkage, and lifecycle information at the time of formation, the system ensures that downstream memory-use operations are controlled, auditable, and enforceable under defined policy conditions.

### Memory-Use Decision Engine

The system includes a memory-use decision engine configured to determine whether and under what conditions a governed memory asset may be used in response to a memory-use request. The memory-use decision engine operates after candidate governed memory assets have been identified and before the requested operation is executed. In this manner, the system separates identification of potentially relevant memory from authorization and control of memory use.

In one embodiment, the memory-use decision engine receives a memory-use request from a requesting actor and generates or receives a request representation corresponding to the memory-use request. The system uses the request representation, together with a searchable memory index or other selection mechanism, to identify one or more candidate governed memory assets. Identification of a candidate governed memory asset does not itself authorize use of the asset.

In retrieval-augmented and agentic AI embodiments, the memory-use decision engine prevents semantically relevant but unsupported or ineligible semantic memory assets from influencing generated outputs, agent actions, memory updates, or downstream model-related artifacts merely because those assets satisfy a relevance-oriented search criterion.

In some embodiments, the requested operation is not limited to plaintext retrieval, but instead comprises AI-driven response generation, summarization, memory updating, actor-associated memory activity, derived-artifact generation, corpus inclusion, retrieval-binding generation, or localized model-package generation. In such embodiments, the memory-use decision engine evaluates whether the candidate governed memory asset is eligible to influence the requested operation under the applicable machine-readable decision conditions, even where the asset satisfies a semantic relevance criterion.

For at least one candidate governed memory asset, the memory-use decision engine evaluates a memory-use decision condition. The memory-use decision condition includes multiple machine-evaluable sub-conditions, including a semantic-support condition, a provenance-validation condition, an authorization condition, and a memory-validity condition. The system may also evaluate additional conditions, including confidence, ambiguity, citation, policy conflict, tenant boundary, risk, or isolation conditions.

The semantic-support condition evaluates whether a relationship between the request representation and a representation associated with the candidate governed memory asset satisfies a defined criterion. The criterion may include a similarity value, distance value, ranking value, relevance measure, threshold, or other machine-readable relationship. The semantic-support condition ensures that the memory asset is sufficiently related to the requested operation before the memory asset is used.

In one implementation, the semantic-support condition is evaluated by computing a machine-readable relationship value between the request representation and a semantic representation associated with the candidate governed memory asset, the relationship value comprising a similarity score, distance value, ranking value, relevance score, or threshold comparison result. The searchable memory index may first return a candidate set, after which the memory-use decision engine applies one or more semantic-support thresholds, ranking cutoffs, or support criteria to determine whether a candidate governed memory asset remains eligible for further evaluation. In some embodiments, multiple semantic-support values may be compared across candidate governed memory assets to determine whether a sufficiently supported subset exists for the requested operation.

The provenance-validation condition evaluates whether the candidate governed memory asset has provenance linkage satisfying a defined source-validity, lineage-validity, auditability, or policy requirement. The system may determine whether the memory asset is linked to a protected source record, ingestion event, prior derived artifact, frozen corpus snapshot, or other authorized source state. A memory asset lacking acceptable provenance linkage may be prevented from influencing an output or downstream artifact even if it satisfies semantic-support criteria.

The authorization condition evaluates whether the requesting actor is permitted to use the candidate governed memory asset for the requested operation. The evaluation may compare actor-specific data with governance metadata, authorization metadata, policy metadata, tenant restrictions, purpose-of-use indicators, or other access-control state associated with the memory asset. The authorization condition may apply role-based, attribute-based, policy-based, purpose-based, tenant-based, contextual, or risk-adaptive authorization logic.

The memory-validity condition evaluates whether the candidate governed memory asset is in a lifecycle state eligible for the requested operation. The system may determine whether version-state data or memory-validity status indicates that the asset is active, conditionally active, frozen, superseded, excluded, forensic-only, archived, tombstoned, retired, pending review, or otherwise restricted. A memory asset may therefore be excluded or limited even if the requesting actor is otherwise authorized and the asset is semantically related to the request.

In some embodiments, the decision engine evaluates additional conditions to refine or constrain the decision. A confidence condition may evaluate reliability or consistency of support. An ambiguity condition may determine whether multiple candidate assets prevent selection of a sufficiently supported result. A citation condition may require linkage between an output and supporting memory assets. A policy conflict condition may identify inconsistent governance states. A tenant boundary condition may prevent use across tenant or domain boundaries. A risk condition may evaluate behavioral, contextual, operational, or security risk. An isolation condition may evaluate whether the execution context satisfies an applicable isolation policy.

In one implementation, the memory-use decision engine evaluates the decision conditions in an ordered sequence comprising candidate-asset intake, semantic-support screening, provenance-validation screening, authorization screening, and memory-validity screening, followed optionally by one or more additional-condition evaluations. In such an implementation, failure of a required condition may terminate unrestricted progression of the candidate governed memory asset and cause generation of a decision result indicating exclusion, limitation, suppression, denial, or review routing. In other implementations, two or more decision conditions may be evaluated in parallel and then combined through deterministic decision logic, weighted policy logic, or rule-priority logic to generate the decision result. The invention is not limited to a single evaluation order, provided that the required machine-readable decision conditions are evaluated before the candidate governed memory asset is permitted to influence the requested operation.

The memory-use decision engine produces a decision result based on the evaluated conditions. The decision result may indicate that the requested operation is permitted, permitted with limitations, denied, suppressed, routed for review, or subject to additional enforcement. The decision result may also identify which conditions were satisfied, which conditions failed, and which policy rules or metadata values controlled the outcome.

The evaluation performed by the memory-use decision engine is machine-executable and based on stored records, computed values, policy rules, and actor-specific data. The decision is not based merely on human discretion or on semantic relevance alone. Even when a candidate governed memory asset is relevant to a request, the engine may prevent its use if provenance, authorization, validity, or other required conditions are not satisfied.

The memory-use decision engine thereby provides a technical enforcement point within the architecture. It ensures that governed memory assets are not allowed to affect retrieval, generated output, memory updates, derived artifact creation, corpus formation, or deployment artifact generation unless the applicable decision conditions support the requested operation.

### Response Policy and Execution Control

The system includes a response policy and execution control subsystem configured to convert the decision result produced by the memory-use decision engine into an enforceable system action. The subsystem ensures that the evaluated decision conditions are not merely advisory, but control whether and how the requested memory-use operation is performed.

In AI-output embodiments, the response policy and execution control subsystem serves as a truthfulness-preserving control layer by limiting generated outputs, summaries, and derivative AI artifacts to governed memory assets that satisfy the applicable semantic-support, provenance-validation, authorization, and memory-validity conditions.

In one embodiment, the response policy comprises machine-readable rules, mappings, thresholds, or policy logic that associate decision results with response modes. The response policy may be selected or modified based on governance metadata, actor-specific data, requested operation type, memory-validity status, risk condition, isolation condition, or other operational context. The response policy may be versioned so that the policy state applied to a particular operation can be reconstructed from the audit records.

In one implementation, the response policy applies a machine-readable mapping between evaluated condition outcomes and selectable response modes. For example, satisfaction of semantic-support, provenance-validation, authorization, and memory-validity conditions may map to a permit or controlled-return response mode; failure of provenance-validation may map to suppression, denial, or metadata-only return; failure of authorization may map to denial, redaction, or review routing; and failure of memory-validity may map to exclusion, restricted return, archival-only treatment, or prevention of downstream writing. Where multiple conditions produce different enforcement implications, the response policy may apply a most-restrictive rule, a rule-priority hierarchy, or an operation-specific override policy to determine the enforced response mode.

In further embodiments, the response policy applies staged use control rather than a binary permit-or-deny model. A first stage may determine whether any use of a candidate governed memory asset is permitted for the requested operation. A second stage may determine the permitted form of use, including plaintext return, redacted return, metadata-only return, summary-only return, citation-limited return, derived-output return, memory-write prevention, output suppression, operation denial, delayed release after secondary approval, or human-review routing. A third stage may determine whether any resulting output, memory update, derived artifact, corpus entry, retrieval binding, or localized model package must inherit governance constraints from the governed memory asset on which it depends.

After the memory-use decision engine evaluates the applicable decision conditions, the response policy and execution control subsystem selects a response mode. The selected response mode may permit the requested operation, limit the requested operation, suppress output, deny the operation, prevent writing of data, return only metadata, return redacted content, return a summary or derived output, restrict output to cited or provenance-supported content, delay release pending secondary approval, or route the request for human or administrative review.

The selected response mode is enforced by controlling execution of one or more downstream operations. If the response mode permits execution, the system may retrieve a governed memory asset, generate output, write a memory update, generate a derived artifact, include an asset in a corpus, or generate a deployment artifact, subject to the permitted scope. If the response mode limits execution, the system may restrict fields, redact portions of content, limit the number or type of returned assets, restrict output to metadata, or constrain generated output to information supported by eligible governed memory assets.

If the selected response mode suppresses or denies the requested operation, the subsystem prevents the operation from producing an output or modifying system state. If the selected response mode prevents writing, the subsystem prevents creation or update of a governed memory asset record or derived artifact. If the selected response mode routes the request for review, the subsystem may suspend execution pending review, record the routing basis, and enforce the final disposition produced by the review process.

The response policy and execution control subsystem may enforce different response modes for different candidate governed memory assets implicated by the same memory-use request. For example, one candidate asset may be returned in plaintext, another may be returned only in redacted form, another may be represented only by metadata, and another may be excluded entirely. The system may aggregate these asset-specific response modes into a final response while maintaining a decision-basis record for each controlled asset or operation.

In embodiments involving output generation or derived-artifact generation, the subsystem may prevent unsupported or unauthorized memory from influencing the generated output or artifact. The subsystem may restrict generation to memory assets satisfying the applicable decision conditions and may associate any generated output or artifact with provenance linkage, governance metadata, version-state data, and audit linkage. In this manner, generation and artifact formation are treated as controlled memory-use operations rather than uncontrolled downstream uses.

In some embodiments, the response policy and execution control subsystem applies hierarchical or staged enforcement. A first stage may determine whether any use of a governed memory asset is permitted. A second stage may determine the permissible form of output. A third stage may determine whether secondary review, redaction, metadata-only return, or memory-write prevention is required. This staged structure allows the system to enforce granular control without reducing the architecture to a binary allow-or-deny mechanism.

The subsystem records the selected response mode and enforcement action in the audit subsystem. The resulting decision-basis record may identify the memory-use request, requesting actor, candidate memory asset, evaluated conditions, selected response mode, policy version, enforcement action, time value, and any suppression, denial, redaction, or review-routing reason. This record enables reconstruction of both the decision and the system behavior that followed from that decision.

The response policy and execution control subsystem therefore provides the mechanism by which the disclosed architecture translates machine-readable governance state into controlled execution. By enforcing a selected response mode before memory can affect output, state, or downstream artifacts, the system maintains governed control over memory-use operations across retrieval, generation, updating, derived artifact creation, corpus formation, and deployment workflows.

### Audit and Decision Traceability

The system includes an audit and decision traceability subsystem configured to record and preserve the basis for memory formation, memory-use decisions, response-mode selection, execution control, and downstream artifact generation. The audit subsystem is integrated with the governed memory store, memory-use decision engine, response policy and execution control subsystem, actor memory lifecycle subsystem, execution-context verification subsystem, and corpus and deployment artifact subsystem.

For each memory-use request, the system generates a structured decision-basis record. The decision-basis record captures information sufficient to reconstruct why a governed memory asset was permitted, limited, suppressed, denied, routed for review, or otherwise controlled. In one embodiment, the decision-basis record identifies the requesting actor, the memory-use request, the requested operation, one or more candidate governed memory assets, evaluated decision conditions, selected response mode, time value, policy version, and enforcement action.

The audit subsystem may also generate audit event records for events occurring before or after a memory-use decision. Such events may include ingestion of protected source records, generation of ingestion metadata, creation of memory units, generation of semantic representations, storage of governed memory asset records, classification or reclassification of assets, updates to governance metadata, updates to authorization rules, changes to version-state data, creation of derived artifacts, corpus formation, deployment-artifact generation, execution-context verification, cleanup operations, and review-routing actions.

The audit subsystem stores decision-basis records and audit event records in a tamper-evident audit structure. The tamper-evident audit structure may include append-only event storage, hash-linked event chains, Merkle-linked structures, digitally signed records, write-once storage, immutable object storage, externally anchored audit digests, or combinations thereof. The particular integrity mechanism may vary, provided that unauthorized modification can be prevented or detected and that records remain available for reconstruction of system behavior.

In one embodiment, each audit event record includes a time value, event type, actor identifier, affected memory asset identifier, policy identifier, response-mode identifier, condition-evaluation result, and integrity information. In another embodiment, audit records are cryptographically or logically linked to related records so that a sequence of operations can be reconstructed from protected source record ingestion through governed memory formation, memory-use evaluation, response enforcement, derived artifact creation, corpus formation, and deployment.

The audit subsystem may record both successful and unsuccessful operations. For example, when a requested operation is denied, suppressed, redacted, limited, or routed for review, the audit subsystem records the condition or policy basis for that outcome. When a memory asset is excluded from a corpus, restricted from output generation, or prevented from being written as a derived artifact, the audit subsystem records the exclusion or prevention basis. This ensures that non-use and partial-use decisions are traceable in the same manner as permitted-use decisions.

The audit subsystem may support retrieval and analysis of audit records by authorized actors or processes. Records may be searched by actor, memory asset, source record, policy identifier, time range, response mode, decision condition, denial reason, suppression reason, lineage reference, or deployment artifact. In some embodiments, access to audit records is itself governed and recorded, thereby preserving traceability of audit review and export operations.

The decision traceability provided by the audit subsystem enables reconstruction of how a particular output, memory state, derived artifact, corpus snapshot, or deployment artifact was produced. Such reconstruction may identify the source records involved, the governed memory assets selected or excluded, the decision conditions evaluated, the response mode applied, the execution context verified, and the audit records generated along the operation path.

By generating structured and tamper-evident records of memory-use decisions and related operations, the audit subsystem provides a technical mechanism for evidentiary reconstruction. The subsystem thereby supports verification that governed memory assets were used only under conditions established by the system and that downstream outputs or artifacts remain traceable to the decision-controlled memory operations from which they were produced.

### Derived Artifacts and Lineage

The system is configured to maintain governance control and traceability when governed memory assets are used to create derived artifacts. A derived artifact may include a summary, transformed record, redacted record, extracted field set, representation, evaluation record, retrieval binding, corpus item, deployment artifact, localized model package, or other data object generated from, influenced by, or linked to one or more governed memory assets.

In one embodiment, a derived artifact remains subject to governed memory-use control notwithstanding transformation of its source content. A summary object, redacted object, extracted field set, evaluation record, retrieval binding, corpus item, deployment artifact, or localized model package derived from one or more governed memory assets remains linked to machine-readable governance state sufficient to determine whether the derived artifact itself may later be viewed, returned, updated, exported, included in a corpus, or incorporated into a deployment workflow.

Derived-artifact generation is treated as a memory-use operation. Accordingly, before a derived artifact is generated, written, stored, exported, or made available for subsequent use, the memory-use decision engine evaluates the applicable decision conditions for the governed memory assets implicated by the operation. The response policy and execution control subsystem then selects and enforces a response mode for the derived-artifact operation.

If the decision conditions do not authorize generation of the derived artifact, the system may suppress the operation, deny the operation, prevent writing of the artifact, limit the artifact to metadata, require redaction, or route the operation for review. If the decision conditions authorize generation subject to limitations, the system may produce a constrained artifact, such as a redacted artifact, summary-only artifact, metadata-only artifact, or citation-limited artifact.

When a derived artifact is generated, the system associates the artifact with lineage information. The lineage information identifies one or more source governed memory assets and may include source-record identifiers, memory-unit identifiers, governed memory asset identifiers, representation-version metadata, policy identifiers, transformation identifiers, actor identifiers, time values, and audit event identifiers. The lineage information may be stored within the derived artifact, in a linked metadata record, in a lineage record, or in a lineage graph.

The system may assign inherited governance metadata or computed governance state to the derived artifact. In one embodiment, the derived artifact inherits governance metadata from a source governed memory asset. In another embodiment, where the artifact is derived from multiple source assets, the system computes an effective governance state by applying a policy rule to the governance metadata of the source assets. The policy rule may apply a most-restrictive classification, a precedence rule, a purpose-of-use limitation, a tenant limitation, a redaction requirement, or a review requirement.

In one implementation, when a derived artifact depends on multiple source governed memory assets, the system computes an effective governance state by applying one or more policy-composition rules across the governance metadata of the contributing source assets. The policy-composition rules may apply a most-restrictive classification, deny-if-any-source-is-denied logic, purpose-of-use intersection logic, tenant-boundary preservation logic, redaction inheritance logic, or review-trigger logic. The resulting computed governance state is then associated with the derived artifact together with lineage information sufficient to identify which source governed memory assets contributed to the computed outcome.

The system may also associate the derived artifact with version-state data indicating whether the artifact is active, conditionally active, frozen, superseded, excluded, forensic-only, archived, tombstoned, retired, pending review, or otherwise eligible for later use. If a source governed memory asset is later reclassified, superseded, invalidated, or restricted, the system may use stored lineage information to identify affected derived artifacts and to update, restrict, retire, flag, or reprocess those artifacts according to policy.

In some embodiments, a derived artifact that is written to the governed memory store becomes a governed memory asset record. In such cases, the system stores the derived artifact with provenance linkage, governance metadata, authorization metadata, representation-version metadata, version-state data, and audit linkage. Subsequent use of the derived artifact is then subject to the same memory-use decision framework as other governed memory assets.

The audit subsystem records derived-artifact operations as decision-basis records or audit event records. Such records may identify the requesting actor, requested operation, source governed memory assets, applied transformation rules, inherited or computed governance metadata, selected response mode, time value, and evaluated decision conditions. These records allow reconstruction of why the derived artifact was permitted, limited, denied, prevented from being written, or routed for review.

By maintaining lineage and governance state across derived artifacts, the system prevents governed memory from escaping control merely because it has been transformed, summarized, redacted, embedded, packaged, or otherwise converted into another form. The system thereby preserves governance continuity from source records through memory assets, derived artifacts, corpus snapshots, deployment artifacts, and later memory-use operations.

### Actor-Based Memory Control

The system includes an actor-based memory control subsystem configured to govern how requesting actors and computational actors create, access, update, and otherwise interact with governed memory assets. The subsystem ensures that memory associated with an actor is subject to the same decision-condition framework, governance metadata, provenance requirements, and audit controls as other governed memory within the system.

In one embodiment, the system associates a requesting actor with actor-specific data, including identity, role, attributes, credentials, tenant association, purpose-of-use indicators, contextual data, and risk indicators. This actor-specific data is used by the memory-use decision engine when evaluating authorization conditions, risk conditions, and other decision conditions for a memory-use request.

The system may maintain actor-associated memory structures, including episodic memory segments or shards. An episodic memory shard may correspond to a task, session, workflow, time interval, domain, or actor identity. Each shard may include one or more governed memory assets or references thereto and may be associated with governance metadata, authorization metadata, version-state data, and an allowed-state indicator defining permissible operations on the shard.

Creation, update, retrieval, freezing, retirement, tombstoning, or archival of actor-associated memory is treated as a memory-use operation. Accordingly, each such operation is evaluated using the memory-use decision engine and enforced through the response policy and execution control subsystem. The system may prevent or limit actor memory operations that do not satisfy semantic-support, provenance-validation, authorization, memory-validity, or other applicable decision conditions.

In further embodiments, actor-associated memory operations are governed using the same decision-condition framework applied to other semantic memory assets within the regulated AI environment, such that semantically relevant but unsupported, unauthorized, stale, superseded, or policy-ineligible actor-associated memory cannot be used to justify an agent action, memory update, generated output, or downstream artifact.

In some embodiments, the system enforces segmentation boundaries across actor memory shards. A requesting actor or computational actor may be restricted from accessing or modifying memory associated with another actor, shard, tenant, or domain unless authorized by governance metadata and policy rules. Cross-segment access attempts may be denied, limited, or routed for review and are recorded in the audit subsystem.

The system may further control actor memory lifecycle transitions. A shard or memory segment may transition between states such as active, conditionally active, frozen, superseded, restricted, archived, or retired. Each transition may be governed by policy rules and recorded as an audit event, including identification of the actor, prior state, resulting state, and policy basis for the transition.

Actor-based memory control may also include monitoring of actor behavior. The system may evaluate patterns of memory-use requests, access frequency, denied operations, cross-boundary attempts, or other telemetry to determine a risk condition associated with the actor. The risk condition may be incorporated into the memory-use decision condition and may influence selection of a response mode, including increased restriction, requirement for review, or temporary limitation of operations.

In some embodiments, the system prevents self-modifying or self-amplifying memory behavior that would bypass governance controls. For example, an actor may be restricted from writing derived artifacts that incorporate unauthorized content, from modifying governance metadata, or from creating memory assets that would later be used to circumvent decision conditions. Such restrictions are enforced through the same decision-condition and response-policy framework applied to other memory-use operations.

The audit subsystem records actor-based memory operations, including permitted operations, denied operations, limited operations, and state transitions. Audit records may include the actor identifier, shard identifier, operation type, evaluated decision conditions, selected response mode, time value, and policy basis. These records enable reconstruction of actor-specific memory behavior and support enforcement, review, and compliance analysis.

By binding actor interactions with memory to the governed memory framework, the system ensures that all memory use—whether initiated by a human user, automated process, or computational actor—remains subject to consistent policy enforcement, traceability, and lifecycle control.

### Execution Context and Isolation Verification

The system includes an execution-context and isolation-verification subsystem configured to ensure that memory-use operations involving governed memory assets are performed within a compliant computational environment. The subsystem extends the decision-condition framework to include verification of where and under what resource conditions a memory-use operation is executed.

In one embodiment, when a memory-use request is received or a requested operation is authorized, the system assigns the operation to an execution context. The execution context may include one or more processes, containers, virtual machines, namespaces, processors, accelerators, memory regions, storage volumes, network paths, runtime identities, or time-bounded assignments. The execution context is not limited to a particular infrastructure and may be implemented across cloud, on-premises, edge, or hybrid environments.

The system generates a resource fingerprint corresponding to the execution context. The resource fingerprint may include identifiers, attributes, measurements, digests, or telemetry values representing assigned resources or isolation boundaries. The resource fingerprint provides a machine-readable representation of the computational environment in which the operation is performed.

The subsystem evaluates the resource fingerprint against an isolation policy. The isolation policy defines acceptable execution contexts for a memory-use operation and may include requirements for resource exclusivity, tenant separation, namespace isolation, process isolation, container isolation, virtual-machine isolation, accelerator-context isolation, encrypted memory handling, storage isolation, network segmentation, or other operational constraints. The isolation policy may vary based on governance metadata, actor-specific data, memory-validity status, risk condition, requested operation, or response mode.

In one implementation, the resource fingerprint comprises one or more machine-readable identifiers or measurements associated with the assigned execution context, including container identifiers, virtual-machine identifiers, namespace identifiers, processor or accelerator assignments, memory-region identifiers, storage-volume identifiers, network-segmentation identifiers, runtime identity values, attestation values, or other environment-state indicators. The subsystem compares the resource fingerprint against an isolation policy specifying acceptable and unacceptable combinations of such values. A mismatch, missing required value, prohibited co-residency condition, namespace violation, storage conflict, or other non-compliant relationship may cause the subsystem to generate an isolation-failure result that is provided to the memory-use decision engine or directly enforced by the response policy and execution control subsystem.

Isolation verification may occur prior to execution, during execution, after execution, or at multiple stages of the operation lifecycle. The system may detect contamination conditions or unauthorized co-residency conditions, including shared processes, shared memory regions, unauthorized storage access, namespace violations, conflicting accelerator usage, or prohibited network paths. When such conditions are detected, the system may deny the operation, suppress output, prevent writing, reassign the operation to a compliant execution context, restrict the response mode, or route the operation for review.

In some embodiments, the isolation condition forms part of the memory-use decision condition evaluated by the memory-use decision engine. In such embodiments, failure of the isolation condition may prevent use of a governed memory asset even if semantic-support, provenance-validation, authorization, and memory-validity conditions are satisfied. In other embodiments, isolation verification is enforced by the response policy and execution control subsystem at execution time.

Accordingly, in some embodiments, authorization to use a governed memory asset depends not only on semantic relevance, provenance, actor authorization, and memory-validity status, but also on whether the requested operation is assigned to and performed within an execution context satisfying the applicable isolation policy. A candidate governed memory asset may therefore be semantically relevant and otherwise authorized, yet still be prevented from influencing a regulated AI operation when the assigned execution context is non-compliant.

The subsystem generates an isolation-verification event corresponding to the evaluation. The event may identify the execution context, resource fingerprint, verification result, detected condition, requesting actor, requested operation, selected response mode, and any enforcement action taken. The isolation-verification event is recorded in the audit subsystem and may be linked to the corresponding decision-basis record.

After completion, denial, or reassignment of a memory-use operation, the system may perform a cleanup operation. Cleanup operations may include memory scrubbing, termination of processes, release of resources, revocation of credentials, removal of temporary data, or verification that no governed memory remains in an unauthorized context. A cleanup-completion event may be recorded to confirm that post-operation isolation requirements have been satisfied.

By verifying execution context and enforcing isolation policies, the system ensures that governed memory assets are not exposed through shared or non-compliant computational environments. The subsystem therefore provides an additional technical control layer that binds memory-use authorization not only to what data may be used, but also to where and how that data may be processed.

### Corpus Formation and Deployment Artifacts

The system includes a corpus formation and deployment artifact subsystem configured to generate controlled data collections and deployable artifacts from governed memory assets while preserving governance metadata, provenance linkage, authorization constraints, version-state data, and audit traceability. The subsystem ensures that downstream uses of memory, including model generation, evaluation, deployment, and configuration, remain subject to the same decision-condition framework applied to primary memory-use operations.

In particular embodiments, corpus formation and deployment-artifact generation support localized artificial intelligence systems by allowing governed semantic memory assets to be assembled into controlled corpus snapshots, evaluation corpora, retrieval bindings, or localized model packages while preserving governance continuity from the originating protected source records.

In one embodiment, the system performs a corpus formation operation in which multiple governed memory assets are selected for inclusion in a corpus. Prior to inclusion, the memory-use decision engine evaluates decision conditions for each candidate governed memory asset. Assets may be included only when the applicable semantic-support, provenance-validation, authorization, memory-validity, and any additional required conditions are satisfied. Assets failing one or more conditions may be excluded, limited to metadata, redacted, or flagged for review according to the response policy.

In one implementation, the subsystem performs asset-by-asset gating before corpus inclusion or artifact formation by evaluating each candidate governed memory asset against the applicable decision conditions and then constructing an asset inclusion list and an asset exclusion list. Only assets assigned to the inclusion list are permitted to contribute content, configuration, representations, bindings, or training-related influence to the resulting corpus snapshot, evaluation corpus, retrieval binding, deployment artifact, or localized model package. Assets assigned to the exclusion list may be omitted, redacted, replaced with metadata-only references, or flagged for review according to the selected response mode.

In further embodiments, corpus formation, retrieval-binding generation, deployment-artifact generation, and localized model-package generation are each governed memory-use operations in which a candidate governed memory asset is not permitted to influence the resulting artifact unless the applicable semantic-support, provenance-validation, authorization, memory-validity, and any additional required decision conditions are satisfied. In this manner, the architecture prevents non-compliant, stale, unauthorized, or unsupported governed memory assets from entering downstream corpus states or localized AI packages merely because such assets were present in the governed memory store.

The system may generate a frozen corpus snapshot. A frozen corpus snapshot is a write-locked, immutable, versioned, or otherwise controlled collection of governed memory assets selected under defined conditions. The snapshot is associated with a snapshot identifier and may include an asset inclusion list, an asset exclusion list, selection criteria, governance metadata, provenance linkage, version-state data, and audit linkage identifying the decision basis for inclusion or exclusion of each asset. Once formed, the frozen corpus snapshot may be prevented from modification during a defined interval or lifecycle state.

The subsystem may generate additional corpus types, including evaluation corpora. An evaluation corpus may include test records, validation data, expected-output records, or other controlled data derived from governed memory assets. Evaluation corpus formation is also treated as a memory-use operation and is subject to the same decision-condition framework.

The subsystem may further generate retrieval bindings. A retrieval binding may include configuration data associating a system component, model, or service with a defined subset of governed memory assets or a frozen corpus snapshot. The retrieval binding may specify permitted memory scopes, response-policy constraints, governance conditions, or access boundaries for subsequent operations.

In one embodiment, the subsystem generates deployment artifacts. A deployment artifact may include configuration data, policy data, retrieval bindings, evaluation data, representation data, or other machine-readable components required to deploy or operate a system in a target environment. Deployment artifact generation is subject to the decision-condition framework to ensure that only authorized governed memory assets influence the resulting artifact.

The subsystem may also generate localized model packages. A localized model package may include model parameters, adapter parameters, tokenizer or vocabulary data, retrieval bindings, configuration records, policy data, evaluation data, or other components derived from governed memory assets or corpus snapshots. The model package may be generated using training, updating, adaptation, or packaging techniques performed within an organization-controlled execution environment. The system maintains linkage between the localized model package and the governed memory assets or corpus snapshot from which it was derived.

The system maintains lineage information for each corpus, snapshot, binding, or deployment artifact. The lineage information may identify source governed memory assets, source protected records, memory units, representation versions, governance metadata, policy identifiers, transformation identifiers, snapshot identifiers, and audit records. This lineage enables reconstruction of how a corpus or artifact was formed and which memory assets contributed to its creation.

When governance metadata, authorization rules, or memory-validity status changes, the system may use lineage information to identify affected corpus snapshots or deployment artifacts. The system may then restrict use, flag for review, regenerate, supersede, or retire affected artifacts according to policy. This ensures that downstream artifacts remain consistent with the current governance state of the underlying memory.

The subsystem records corpus formation and deployment artifact operations in the audit subsystem. Decision-basis records and audit event records may identify the requesting actor, selected memory assets, excluded memory assets, evaluated decision conditions, selected response mode, snapshot identifier, artifact identifier, time value, and policy basis. These records enable reconstruction of corpus formation and deployment decisions.

By treating corpus formation and deployment artifact generation as governed memory-use operations, the system prevents governed memory from being extracted into uncontrolled datasets or deployment packages. The subsystem ensures that governance state, provenance linkage, and decision-condition enforcement persist across the entire lifecycle of memory, from ingestion through storage, evaluation, artifact generation, and deployment.

In some embodiments, governed memory assets may give rise to controlled surrogate artifacts, including digital-twin-based or other surrogate-data-based artifacts, for use in private distillation or localized model-improvement workflows. Such surrogate artifacts are treated as governed downstream objects and may be harvested, transformed, filtered, admitted, excluded, or packaged only under machine-readable governance conditions sufficient to preserve provenance awareness, policy compliance, and audit traceability.

### Implementation Variants

The disclosed architecture may be implemented using different computing infrastructures, storage substrates, representation techniques, policy engines, audit mechanisms, and deployment models while preserving the core governed memory-use control framework. The invention is not limited to a particular vendor product, model architecture, database technology, indexing technique, cryptographic primitive, or deployment environment.

In some embodiments, the governed memory store may be implemented using one or more vector stores, graph databases, relational databases, object stores, document stores, key-value stores, searchable archives, sparse indexes, multimodal memory stores, encrypted local caches, distributed storage systems, or hybrid combinations thereof. The governed memory store may be centralized, distributed, replicated, sharded, tenant-partitioned, edge-local, cloud-based, on-premises, or implemented across multiple environments.

The memory formation subsystem may generate dense vector representations, sparse vector representations, graph representations, symbolic representations, multimodal representations, hybrid search representations, indexed representations, or other searchable representations. Such representations may be generated using internally trained models, externally trained models, rule-based transformations, statistical transformations, symbolic encoders, multimodal encoders, or combinations thereof. The architecture does not require a specific representation dimensionality, model type, training method, or retrieval algorithm.

Candidate governed memory assets may be identified using approximate nearest-neighbor search, exact similarity search, graph traversal, relational query, keyword search, sparse retrieval, hybrid retrieval, rule-based filtering, metadata filtering, ranking pipelines, or other selection techniques. Identification of candidate assets remains distinct from authorization of memory use, and candidate identification alone does not permit a governed memory asset to influence a requested operation.

The memory-use decision engine may be implemented using rules, thresholds, decision tables, policy graphs, executable policy code, weighted scoring logic, deterministic evaluation logic, workflow logic, or combinations thereof. The ordering, grouping, or weighting of decision conditions may vary, provided that use of a governed memory asset is conditioned on evaluation of machine-readable decision criteria.

The response policy and execution control subsystem may be implemented as an application-layer enforcement component, middleware component, policy-enforcement point, workflow step, service gateway, runtime controller, or distributed control mechanism. Response modes may be enforced at the storage layer, application layer, output layer, model-interaction layer, workflow layer, deployment layer, or combinations thereof.

The audit subsystem may be implemented using append-only logs, cryptographic chains, signed records, database audit tables, immutable object stores, write-once storage, distributed ledgers, externally anchored digests, or other integrity-preserving mechanisms. Audit records may be stored locally, replicated across nodes, exported to archive systems, or anchored to external verification systems.

The execution-context and isolation-verification subsystem may be implemented using operating-system controls, container orchestration systems, hypervisors, trusted execution environments, hardware isolation, namespace management, accelerator partitioning, memory encryption, storage isolation, network segmentation, runtime measurement, or combinations thereof. Resource fingerprints may be based on identifiers, measurements, digests, telemetry values, policy labels, or runtime attestations.

Actor-based memory control may be implemented in single-actor systems, multi-user systems, multi-tenant systems, automated workflow systems, service-based architectures, or systems involving autonomous or semi-autonomous computational actors. Actor identity and authorization may be derived from identity providers, credentials, certificates, access tokens, policy attributes, contextual data, or internal actor registries.

Corpus formation and deployment artifact generation may be implemented using data pipeline tools, packaging systems, evaluation frameworks, deployment orchestration systems, model-update pipelines, retrieval-configuration systems, or other artifact-generation mechanisms. Deployment artifacts may be configured for private servers, cloud environments, edge devices, mobile-class devices, isolated execution environments, or hybrid deployment environments.

The subsystems described herein may be combined, separated, replicated, or distributed. For example, the memory-use decision engine and response control subsystem may be implemented as a single service or as separate services. The audit subsystem may be local to a node or provided as a centralized audit service. The governed memory store may be colocated with the decision engine or accessed through a secured network interface.

The order of operations described in this specification may be varied where technically appropriate. Certain operations may be performed sequentially, in parallel, asynchronously, or in response to events, provided that the required decision conditions are evaluated before a governed memory asset is permitted to affect a memory-use operation. Additional operations may be added, and certain optional operations may be omitted, without departing from the disclosed architecture.

The foregoing implementation variants demonstrate that the inventive concept resides in the association of machine-readable governance state with memory assets, the evaluation of decision conditions before memory use, the selection and enforcement of response modes, and the recording of decision-basis information. Variations in underlying storage, representation, infrastructure, or deployment technology do not remove a system from the scope of the disclosed governed memory-use control architecture when those functional relationships are maintained.

### DETAILED DESCRIPTION OF THE FIGURES

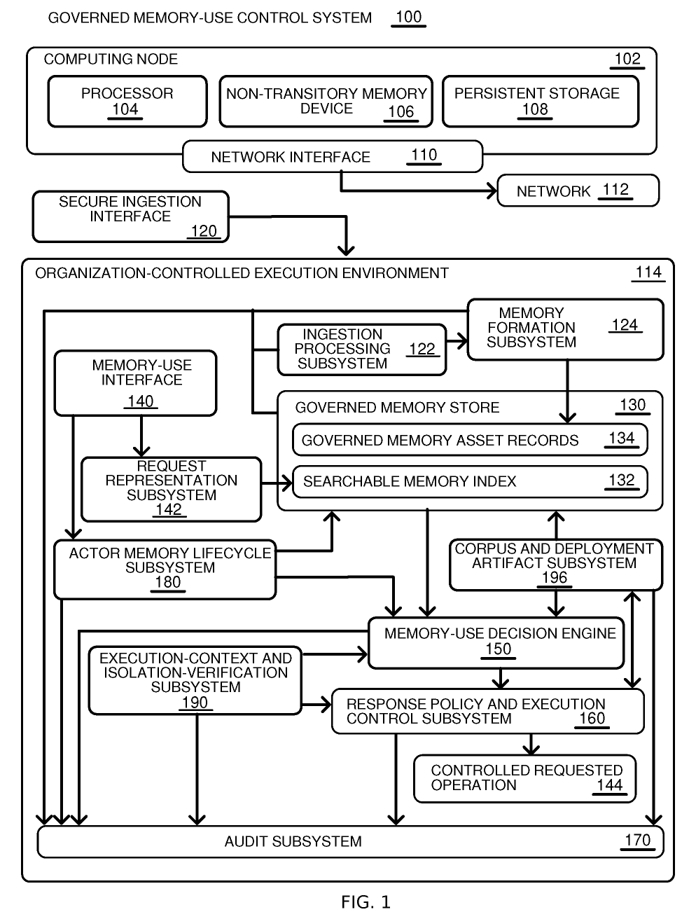

### FIG. 1. Governed Memory-Use Control Architecture

FIG. 1 illustrates a governed memory-use control system 100 implemented within a regulated computing environment. The system 100 is configured to form governed memory assets, store governed memory asset records 134, evaluate machine-readable decision conditions, enforce response modes, generate audit records, verify execution contexts, and control downstream corpus and deployment artifact operations.

The system 100 includes one or more computing nodes 102. Each computing node 102 may include one or more processors 104, one or more non-transitory memory devices 106 storing executable instructions, one or more persistent storage devices 108, and one or more network interfaces 110. The computing nodes 102 may communicate through one or more networks 112 and may operate within an organization-controlled execution environment 114.

A secure ingestion interface 120 receives protected source records through authenticated communication channels. The secure ingestion interface 120 is coupled to an ingestion processing subsystem 122, which generates ingestion metadata records, performs validation or normalization, and establishes provenance linkage for received protected source records.

A memory formation subsystem 124 receives protected source records and associated ingestion metadata from the ingestion processing subsystem 122. The memory formation subsystem 124 processes the protected source records into memory units, generates semantic representations, associates governance metadata, authorization metadata, representation-version metadata, and version-state data, and forms governed memory asset records 134.

A governed memory store 130 stores the governed memory asset records 134 produced by the memory formation subsystem 124. The governed memory store 130 includes or is associated with a searchable memory index 132 configured to identify candidate governed memory asset records 134 based on a request representation, metadata condition, rule, similarity measure, relevance measure, or other selection criterion.

A memory-use interface 140 receives memory-use requests from requesting actors. The memory-use interface 140 is coupled to a request representation subsystem 142, which generates or receives a request representation corresponding to a memory-use request.

The request representation subsystem 142 communicates with the searchable memory index 132 to identify one or more candidate governed memory asset records 134 stored in the governed memory store 130. Identification of candidate governed memory asset records 134 does not itself authorize use of those records.

A memory-use decision engine 150 evaluates one or more memory-use decision conditions for at least one candidate governed memory asset record 134. The memory-use decision conditions include a semantic-support condition, a provenance-validation condition, an authorization condition, and a memory-validity condition. In some embodiments, the memory-use decision engine 150 further evaluates one or more confidence, ambiguity, citation, policy conflict, tenant boundary, risk, or isolation conditions. The memory-use decision engine 150 produces a decision result.

A response policy and execution control subsystem 160 receives the decision result from the memory-use decision engine 150 and selects a response mode according to a response policy. The subsystem 160 enforces the selected response mode by controlling execution of a controlled requested operation 144. Enforcement may include permitting, limiting, suppressing, denying, redacting, preventing writing, controlling export or disclosure, delaying release, or routing for review before a governed memory asset record 134 is permitted to affect the controlled requested operation 144.

An audit subsystem 170 generates and stores decision-basis records and audit event records. The audit subsystem 170 may receive data from the ingestion processing subsystem 122, memory formation subsystem 124, governed memory store 130, searchable memory index 132, governed memory asset records 134, memory-use interface 140, request representation subsystem 142, controlled requested operation 144, memory-use decision engine 150, response policy and execution control subsystem 160, actor memory lifecycle subsystem 180, execution-context and isolation-verification subsystem 190, and corpus and deployment artifact subsystem 196. The audit subsystem 170 stores records in a tamper-evident audit structure.

An actor memory lifecycle subsystem 180 manages actor-associated memory, including episodic memory segments or shards associated with a requesting actor or computational actor. The actor memory lifecycle subsystem 180 may control creation, writing, updating, freezing, retiring, tombstoning, archiving, or retrieval of actor-associated memory through the same decision-condition and response-policy framework used for other governed memory assets.

An execution-context and isolation-verification subsystem 190 identifies an execution context assigned to a memory-use operation, generates or receives a resource fingerprint, evaluates the resource fingerprint against an isolation policy, and generates an isolation-verification event. The result of isolation verification may be provided to the memory-use decision engine 150, the response policy and execution control subsystem 160, and the audit subsystem 170.

A corpus and deployment artifact subsystem 196 forms higher-order controlled objects from governed memory assets. Such objects may include frozen corpus snapshots, evaluation corpora, retrieval bindings, deployment artifacts, localized model packages, or deployment packages. The corpus and deployment artifact subsystem 196 operates under the decision-condition and response-policy framework and associates generated objects with lineage information, governance metadata, version-state data, and audit linkage.

### REFERENCE LIST

100 – GOVERNED MEMORY-USE CONTROL SYSTEM
102 – COMPUTING NODE
104 – PROCESSOR
106 – NON-TRANSITORY MEMORY DEVICE
108 – PERSISTENT STORAGE DEVICE
110 – NETWORK INTERFACE
112 – NETWORK
114 – ORGANIZATION-CONTROLLED EXECUTION ENVIRONMENT
120 – SECURE INGESTION INTERFACE
122 – INGESTION PROCESSING SUBSYSTEM
124 – MEMORY FORMATION SUBSYSTEM
130 – GOVERNED MEMORY STORE
132 – SEARCHABLE MEMORY INDEX
134 – GOVERNED MEMORY ASSET RECORDS
140 – MEMORY-USE INTERFACE
142 – REQUEST REPRESENTATION SUBSYSTEM
144 – CONTROLLED REQUESTED OPERATION
150 – MEMORY-USE DECISION ENGINE
160 – RESPONSE POLICY AND EXECUTION CONTROL SUBSYSTEM
170 – AUDIT SUBSYSTEM
180 – ACTOR MEMORY LIFECYCLE SUBSYSTEM
190 – EXECUTION-CONTEXT AND ISOLATION-VERIFICATION SUBSYSTEM
196 – CORPUS AND DEPLOYMENT ARTIFACT SUBSYSTEM

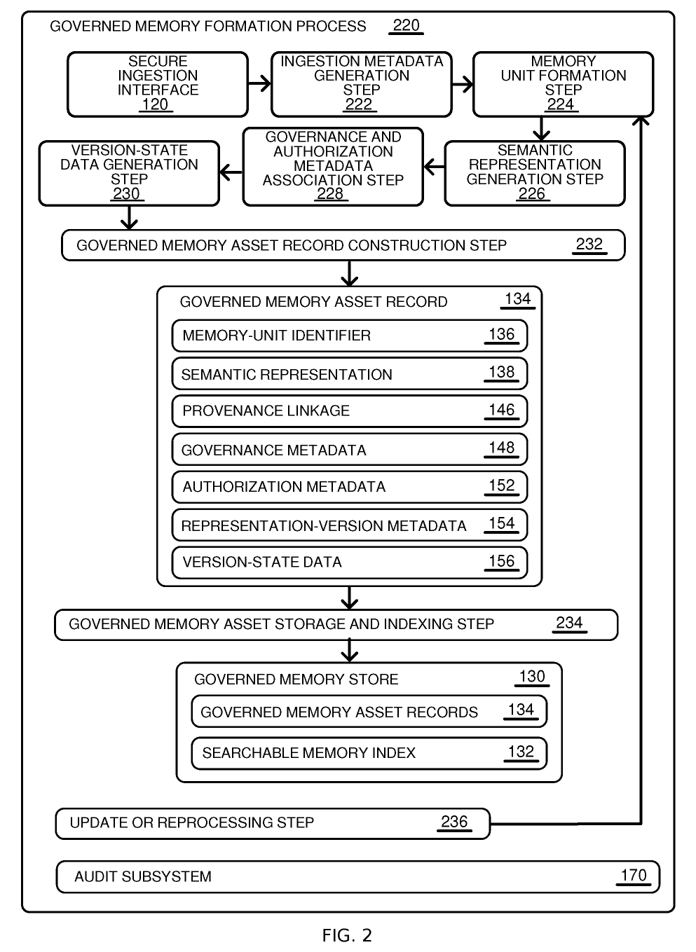

### FIG. 2. Governed Memory Formation Flow

FIG. 2 illustrates a governed memory formation process 220 by which protected source records are transformed into governed memory asset records 134 within the governed memory-use control system 100. Reference numbers from FIG. 1 are reused where applicable.

The process 220 begins when a protected source record is received at the secure ingestion interface 120 through an authenticated communication channel and provided to the ingestion processing subsystem 122.

At step 222, the ingestion processing subsystem 122 generates an ingestion metadata record associated with the protected source record. The ingestion metadata record includes at least a source identifier and a time value and may further include validation results, policy indicators, or preliminary governance metadata.

At step 224, the protected source record is provided to the memory formation subsystem 124, which processes the protected source record into one or more memory units. The formation of memory units may include segmentation, partitioning, extraction, structuring, normalization, or transformation. Each memory unit is associated with a memory-unit identifier 136 and retains provenance linkage 146 to the originating protected source record.

At step 226, the memory formation subsystem 124 generates one or more semantic representations 138 corresponding to the memory units. The semantic representations 138 are generated within the organization-controlled execution environment 114 and are configured to support comparison, search, ranking, or evaluation. Representation-version metadata 154 is associated with each generated semantic representation 138.

At step 228, the system associates governance metadata 148 and authorization metadata 152 with each memory unit. Governance metadata 148 may include compliance or policy metadata, and authorization metadata 152 is configured to support evaluation of whether a requesting actor is permitted to use the memory unit in a subsequent memory-use operation.

At step 230, the system generates version-state data 156 for each memory unit. The version-state data 156 indicates a memory-validity status defining whether the memory unit is active, restricted, superseded, archived, or otherwise subject to lifecycle constraints.

At step 232, the memory formation subsystem 124 constructs governed memory asset records 134. Each governed memory asset record 134 includes or is associated with a memory-unit identifier 136, semantic representation 138, provenance linkage 146, governance metadata 148, authorization metadata 152, representation-version metadata 154, and version-state data 156.

At step 234, the governed memory asset records 134 are stored in the governed memory store 130. The storage process includes indexing of the governed memory asset records 134 in the searchable memory index 132 to enable later identification of candidate governed memory asset records 134.

In some embodiments, at step 236, the system performs update or reprocessing operations. When a protected source record, governance metadata 148, authorization metadata 152, representation-version metadata 154, version-state data 156, or a memory formation process changes, updated governed memory asset records 134 may be generated, and prior versions may be superseded, restricted, or archived while maintaining provenance linkage 146 and audit traceability through the audit subsystem 170.

### REFERENCE LIST

100 – GOVERNED MEMORY-USE CONTROL SYSTEM
114 – ORGANIZATION-CONTROLLED EXECUTION ENVIRONMENT
120 – SECURE INGESTION INTERFACE
122 – INGESTION PROCESSING SUBSYSTEM
124 – MEMORY FORMATION SUBSYSTEM
130 – GOVERNED MEMORY STORE
132 – SEARCHABLE MEMORY INDEX
134 – GOVERNED MEMORY ASSET RECORD
136 – MEMORY-UNIT IDENTIFIER
138 – SEMANTIC REPRESENTATION
146 – PROVENANCE LINKAGE
148 – GOVERNANCE METADATA
152 – AUTHORIZATION METADATA
154 – REPRESENTATION-VERSION METADATA
156 – VERSION-STATE DATA
170 – AUDIT SUBSYSTEM
220 – GOVERNED MEMORY FORMATION PROCESS
222 – INGESTION METADATA GENERATION STEP
224 – MEMORY UNIT FORMATION STEP
226 – SEMANTIC REPRESENTATION GENERATION STEP
228 – GOVERNANCE AND AUTHORIZATION METADATA ASSOCIATION STEP
230 – VERSION-STATE DATA GENERATION STEP
232 – GOVERNED MEMORY ASSET RECORD CONSTRUCTION STEP
234 – GOVERNED MEMORY ASSET STORAGE AND INDEXING STEP
236 – UPDATE OR REPROCESSING STEP

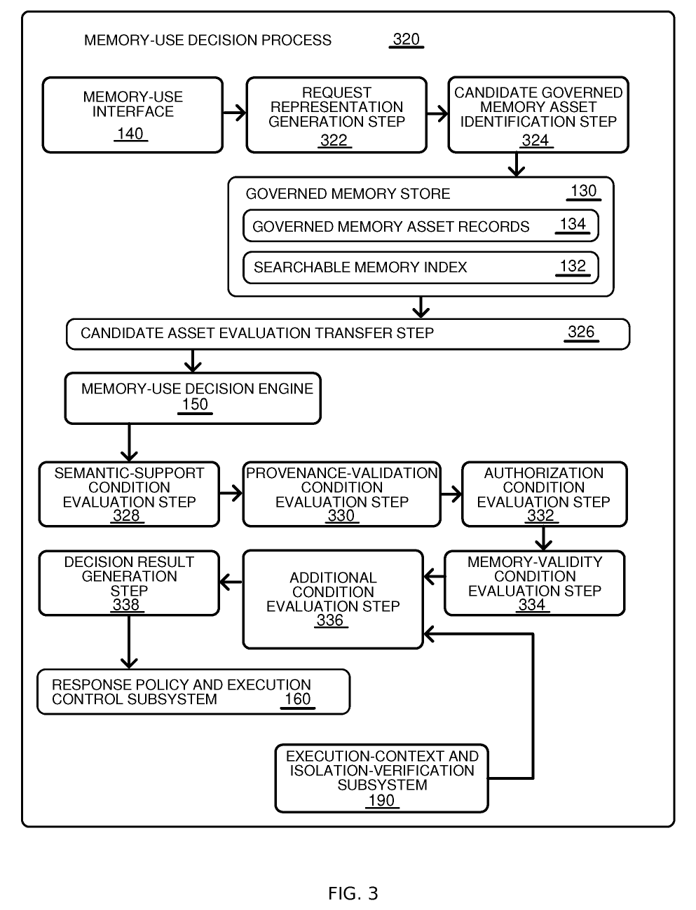

### FIG. 3. Memory-Use Decision Engine Flow

FIG. 3 illustrates a memory-use decision process 320 performed by the memory-use decision engine 150 in response to a memory-use request. Reference numbers from FIGS. 1 and 2 are reused where applicable.

The process 320 begins when a memory-use request is received at the memory-use interface 140 from a requesting actor. The memory-use request is provided to the request representation subsystem 142.

At step 322, the request representation subsystem 142 generates or receives a request representation corresponding to the memory-use request. The request representation may be a semantic representation, structured representation, or other machine-readable representation suitable for comparison, search, ranking, or evaluation.

At step 324, the request representation is used with the searchable memory index 132 to identify one or more candidate governed memory asset records stored in the governed memory store 130. Candidate identification may be based on similarity, relevance, ranking, metadata filtering, rule-based selection, or other selection criteria. Identification of a candidate governed memory asset record does not itself authorize use of the record.

At step 326, the candidate governed memory asset records are provided to the memory-use decision engine 150 for evaluation.

At step 328, the memory-use decision engine 150 evaluates a semantic-support condition for at least one candidate governed memory asset record. The semantic-support condition determines whether a relationship between the request representation and a semantic representation associated with the candidate governed memory asset record satisfies a defined criterion.

At step 330, the memory-use decision engine 150 evaluates a provenance-validation condition. The provenance-validation condition determines whether the candidate governed memory asset record maintains acceptable provenance linkage to a protected source record, ingestion event, prior governed memory asset, frozen corpus snapshot, derived artifact, or other authorized source state.

At step 332, the memory-use decision engine 150 evaluates an authorization condition. The authorization condition compares actor-specific data associated with the requesting actor against governance metadata, authorization metadata, policy metadata, tenant restrictions, purpose-of-use indicators, or other access-control state associated with the candidate governed memory asset record.

At step 334, the memory-use decision engine 150 evaluates a memory-validity condition. The memory-validity condition determines whether version-state data or memory-validity status associated with the candidate governed memory asset record permits the requested operation.

At step 336, the memory-use decision engine 150 may evaluate one or more additional conditions. The additional conditions may include a confidence condition, ambiguity condition, citation condition, policy conflict condition, tenant boundary condition, risk condition, or isolation condition. An isolation condition may be based on information received from the execution-context and isolation-verification subsystem 190.

At step 338, the memory-use decision engine 150 aggregates the evaluated conditions and generates a decision result. The decision result may indicate that the requested operation is permitted, permitted with limitations, denied, suppressed, routed for review, or subject to additional enforcement. The decision result is provided to the response policy and execution control subsystem 160.

### REFERENCE LIST

130 – GOVERNED MEMORY STORE
132 – SEARCHABLE MEMORY INDEX
140 – MEMORY-USE INTERFACE
142 – REQUEST REPRESENTATION SUBSYSTEM
150 – MEMORY-USE DECISION ENGINE
160 – RESPONSE POLICY AND EXECUTION CONTROL SUBSYSTEM
190 – EXECUTION-CONTEXT AND ISOLATION-VERIFICATION SUBSYSTEM
320 – MEMORY-USE DECISION PROCESS
322 – REQUEST REPRESENTATION GENERATION STEP
324 – CANDIDATE GOVERNED MEMORY ASSET IDENTIFICATION STEP
326 – CANDIDATE ASSET EVALUATION TRANSFER STEP
328 – SEMANTIC-SUPPORT CONDITION EVALUATION STEP
330 – PROVENANCE-VALIDATION CONDITION EVALUATION STEP
332 – AUTHORIZATION CONDITION EVALUATION STEP
334 – MEMORY-VALIDITY CONDITION EVALUATION STEP
336 – ADDITIONAL CONDITION EVALUATION STEP
338 – DECISION RESULT GENERATION STEP

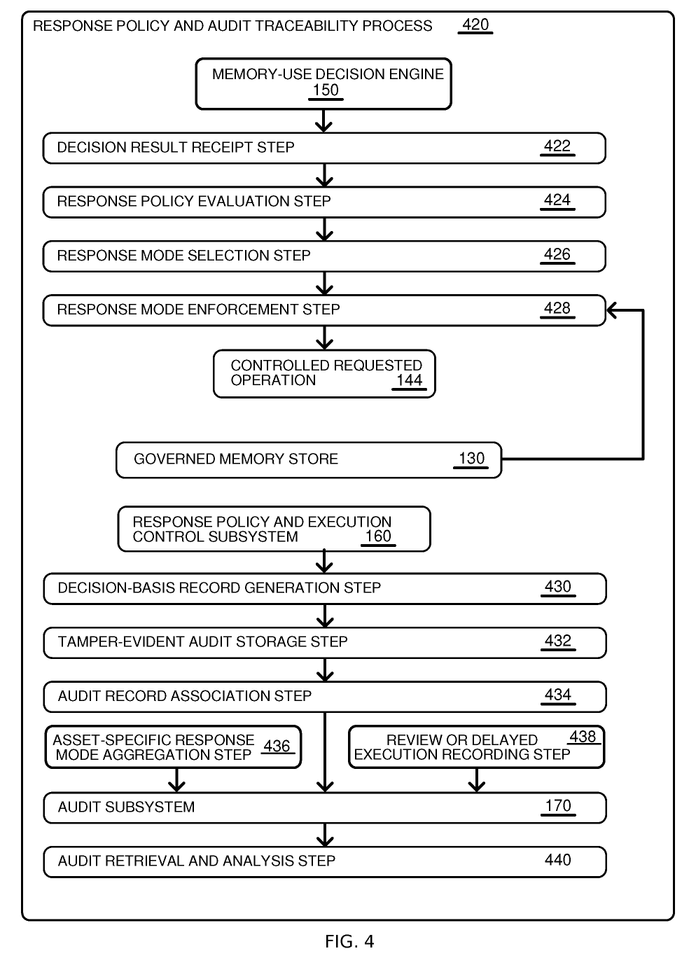

FIG. 4 - Response Policy and Audit Traceability Flow

FIG. 4 illustrates a response policy and execution control process 420 and associated audit traceability performed by the response policy and execution control subsystem 160 and the audit subsystem 170. Reference numbers from FIGS. 1–3 are reused where applicable.

The process 420 begins at step 422, where the response policy and execution control subsystem 160 receives a decision result from the memory-use decision engine 150.

At step 424, the response policy and execution control subsystem 160 evaluates a response policy corresponding to the decision result. The response policy comprises machine-readable rules, mappings, or logic that associate decision-condition outcomes with one or more response modes. The evaluation may consider governance metadata, authorization metadata, version-state data, actor-specific data, requested operation type, or contextual parameters.

At step 426, the subsystem 160 selects a response mode based on the response policy evaluation. The response mode may include permitting execution, limiting execution, returning plaintext content, returning redacted content, returning metadata-only information, generating a summary or derived output, restricting output to provenance-supported content, suppressing output, denying the operation, preventing writing, controlling export or disclosure, delaying execution pending secondary approval, or routing the request for review.

At step 428, the response policy and execution control subsystem 160 enforces the selected response mode by controlling execution of the controlled requested operation 144. Enforcement may include retrieving governed memory asset records from the governed memory store 130, restricting or modifying output, excluding certain candidate assets, preventing write operations, or controlling export or disclosure of governed memory asset records or derived artifacts.

At step 430, the audit subsystem 170 generates a structured decision-basis record corresponding to the memory-use request. The decision-basis record includes at least the requesting actor, the memory-use request, one or more candidate governed memory asset records, the evaluated decision conditions, the selected response mode, a time value, and a decision basis.

At step 432, the audit subsystem 170 stores the decision-basis record and associated audit event records in a tamper-evident audit structure. The storage may include append-only logging, hash-linked record structures, or other integrity-preserving mechanisms.

At step 434, the audit subsystem 170 associates the decision-basis record with related audit event records generated during ingestion, memory formation, and decision evaluation. Such associations enable reconstruction of the lifecycle of governed memory asset records and their use in the requested operation.

At step 436, when multiple candidate governed memory asset records are implicated by the memory-use request, the response policy and execution control subsystem 160 may apply different response modes to different candidate governed memory asset records and aggregate the resulting outputs into a final response.

At step 438, when the selected response mode includes routing for review or delayed execution, the subsystem 160 may suspend execution and generate an audit event indicating a review condition or approval dependency. Subsequent actions may be recorded as additional audit event records linked to the original decision-basis record.

At step 440, the audit subsystem 170 enables retrieval and analysis of stored audit records based on one or more criteria including requesting actor, governed memory asset identifier, response mode, policy identifier, or time value.

### REFERENCE LIST

130 – GOVERNED MEMORY STORE
144 – CONTROLLED REQUESTED OPERATION
150 – MEMORY-USE DECISION ENGINE
160 – RESPONSE POLICY AND EXECUTION CONTROL SUBSYSTEM
170 – AUDIT SUBSYSTEM
420 – RESPONSE POLICY AND AUDIT TRACEABILITY PROCESS
422 – DECISION RESULT RECEIPT STEP
424 – RESPONSE POLICY EVALUATION STEP
426 – RESPONSE MODE SELECTION STEP
428 – RESPONSE MODE ENFORCEMENT STEP
430 – DECISION-BASIS RECORD GENERATION STEP
432 – TAMPER-EVIDENT AUDIT STORAGE STEP
434 – AUDIT RECORD ASSOCIATION STEP
436 – ASSET-SPECIFIC RESPONSE MODE AGGREGATION STEP
438 – REVIEW OR DELAYED EXECUTION RECORDING STEP
440 – AUDIT RETRIEVAL AND ANALYSIS STEP

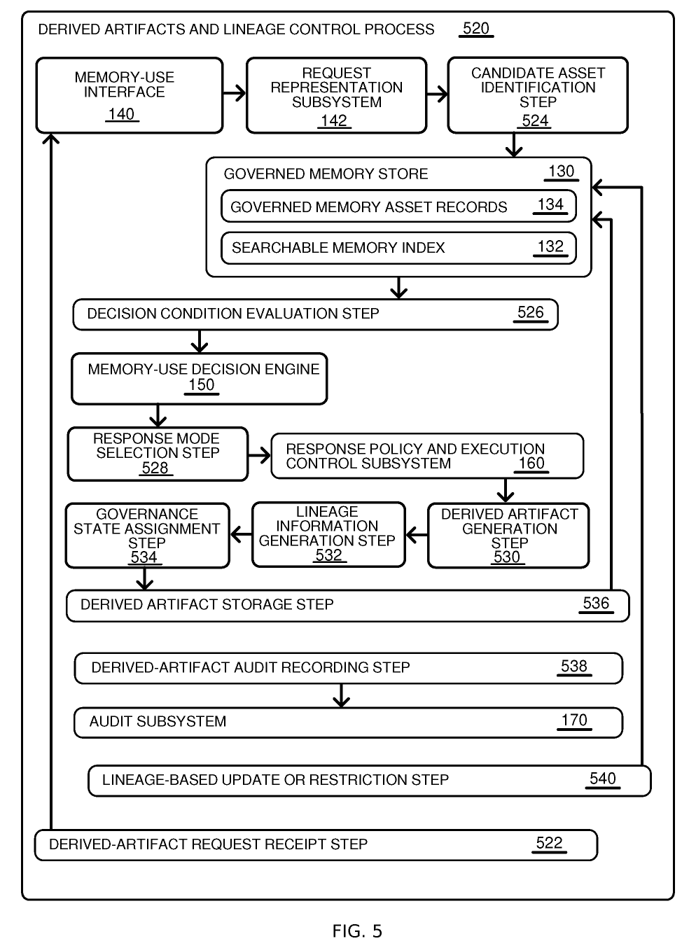

FIG. 5 - Derived Artifacts and Lineage Control

FIG. 5 illustrates a derived-artifact generation and lineage control process 520 performed by the system 100, including the memory-use decision engine 150, the response policy and execution control subsystem 160, the governed memory store 130, the searchable memory index 132, and the audit subsystem 170. Reference numbers from FIGS. 1–4 are reused where applicable.

The process 520 begins at step 522, where a memory-use request involving derived-artifact generation is received at the memory-use interface 140 from a requesting actor and processed by the request representation subsystem 142.

At step 524, candidate governed memory asset records are identified from the governed memory store 130 using the searchable memory index 132 based on a request representation generated by the request representation subsystem 142.

At step 526, the memory-use decision engine 150 evaluates decision conditions for at least one candidate governed memory asset record, including a semantic-support condition, a provenance-validation condition, an authorization condition, and a memory-validity condition, and optionally one or more additional conditions.

At step 528, the response policy and execution control subsystem 160 selects a response mode based on the evaluated decision conditions and determines whether derived-artifact generation is permitted, limited, suppressed, denied, prevented from being written, or routed for review.

At step 530, when permitted, the system generates a derived artifact from one or more source governed memory asset records. The derived artifact may include a transformed record, summary, extracted data object, evaluation record, retrieval binding, corpus element, deployment artifact, or localized model package.

At step 532, the system generates lineage information associated with the derived artifact. The lineage information identifies one or more source governed memory asset records and may include memory-unit identifiers, provenance linkage, representation-version metadata, governance metadata, policy identifiers, transformation identifiers, actor identifiers, and time values. The lineage information may be stored in a lineage record or represented within a lineage graph.

At step 534, the system assigns governance metadata, authorization metadata, and version-state data to the derived artifact. The assigned governance state may be inherited from one or more source governed memory asset records or computed based on policy rules applied across multiple source assets.

At step 536, the system stores the derived artifact in the governed memory store 130 as a governed memory asset record when the response mode permits writing. The stored record includes lineage information and is subject to subsequent evaluation by the memory-use decision engine 150.

At step 538, the audit subsystem 170 generates an audit event record or decision-basis record corresponding to the derived-artifact generation. The record may include the requesting actor, the memory-use request, the source governed memory asset records, the evaluated decision conditions, the selected response mode, the derived artifact, the lineage information, and a time value.

At step 540, when governance metadata, authorization conditions, or memory-validity status associated with a source governed memory asset changes, the system may use lineage information to identify affected derived artifacts and perform update, restriction, supersession, retirement, or review operations, which are recorded by the audit subsystem 170.

### REFERENCE LIST

100 – GOVERNED MEMORY-USE CONTROL SYSTEM
130 – GOVERNED MEMORY STORE
132 – SEARCHABLE MEMORY INDEX
140 – MEMORY-USE INTERFACE
142 – REQUEST REPRESENTATION SUBSYSTEM
150 – MEMORY-USE DECISION ENGINE
160 – RESPONSE POLICY AND EXECUTION CONTROL SUBSYSTEM
170 – AUDIT SUBSYSTEM
520 – DERIVED ARTIFACTS AND LINEAGE CONTROL PROCESS
522 – DERIVED-ARTIFACT REQUEST RECEIPT STEP
524 – CANDIDATE ASSET IDENTIFICATION STEP
526 – DECISION CONDITION EVALUATION STEP
528 – RESPONSE MODE SELECTION STEP
530 – DERIVED ARTIFACT GENERATION STEP
532 – LINEAGE INFORMATION GENERATION STEP
534 – GOVERNANCE STATE ASSIGNMENT STEP
536 – DERIVED ARTIFACT STORAGE STEP
538 – DERIVED-ARTIFACT AUDIT RECORDING STEP
540 – LINEAGE-BASED UPDATE OR RESTRICTION STEP

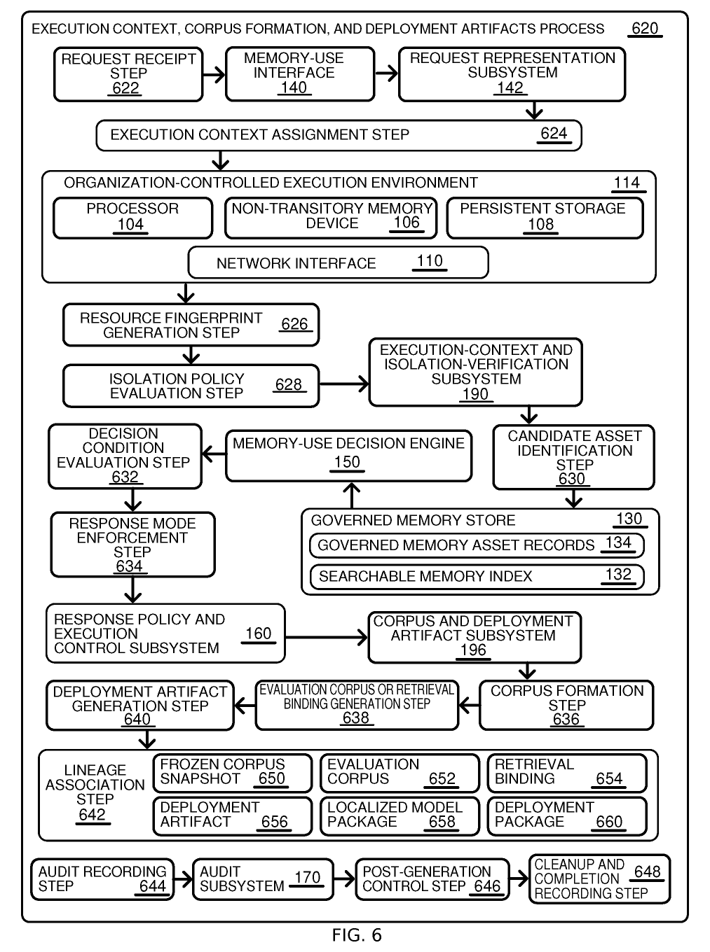

FIG. 6 - Execution Context, Corpus Formation, and Deployment Artifacts

FIG. 6 illustrates a process 620 for execution-context verification, corpus formation, and deployment-artifact generation performed by the system 100, including the execution-context and isolation-verification subsystem 190, the memory-use decision engine 150, the response policy and execution control subsystem 160, the governed memory store 130, the searchable memory index 132, the governed memory asset records 134, the corpus and deployment artifact subsystem 196, and the audit subsystem 170. Reference numbers from FIGS. 1–5 are reused where applicable.

The process 620 begins at step 622, where a memory-use request involving corpus formation, deployment-artifact generation, localized model-package generation, or related downstream operations is received at the memory-use interface 140 and processed by the request representation subsystem 142.

At step 624, the system assigns the requested operation to an execution context within the organization-controlled execution environment 114. The execution context may include one or more processes, containers, virtual machines, namespaces, processors 104, non-transitory memory devices 106, persistent storage devices 108, or network interfaces 110.

At step 626, the execution-context and isolation-verification subsystem 190 generates a resource fingerprint corresponding to the assigned execution context. The resource fingerprint may include identifiers, attributes, measurements, or telemetry values representing the computational environment.

At step 628, the execution-context and isolation-verification subsystem 190 evaluates the resource fingerprint against an isolation policy. If the execution context fails to satisfy the isolation policy, the system may deny the operation, suppress execution, reassign the operation, restrict response modes, or route the operation for review through the response policy and execution control subsystem 160.

At step 630, when the execution context satisfies the isolation policy, the system identifies candidate governed memory asset records 134 from the governed memory store 130 using the searchable memory index 132 based on the request representation generated by the request representation subsystem 142.

At step 632, the memory-use decision engine 150 evaluates decision conditions for each candidate governed memory asset record 134, including semantic-support, provenance-validation, authorization, and memory-validity conditions, and optionally additional conditions.

At step 634, the response policy and execution control subsystem 160 selects and enforces a response mode for each candidate governed memory asset record 134, determining whether the asset may be included, limited, excluded, or otherwise controlled.

At step 636, the corpus and deployment artifact subsystem 196 performs a corpus formation operation by selecting governed memory asset records 134 that satisfy the applicable decision conditions and assembling them into a corpus. The corpus may include a frozen corpus snapshot 650 associated with a snapshot identifier and may include asset inclusion and exclusion records.

At step 638, the corpus and deployment artifact subsystem 196 may generate additional data structures, including an evaluation corpus 652 and one or more retrieval bindings 654 associating system components with selected governed memory asset records 134 or corpus snapshots.

At step 640, the corpus and deployment artifact subsystem 196 generates one or more deployment artifacts 656, including configuration data, policy data, retrieval bindings, evaluation data, or representation data. In some embodiments, the corpus and deployment artifact subsystem 196 generates a localized model package 658 derived from governed memory asset records 134 or corpus snapshots. In further embodiments, the subsystem 196 may generate a deployment package 660 comprising one or more deployment artifacts, retrieval bindings, policy data, evaluation data, localized model package components, or related deployment components.

At step 642, the system associates lineage information with each corpus, snapshot, retrieval binding 654, deployment artifact 656, localized model package 658, or deployment package 660, identifying source governed memory asset records 134 and related metadata.

At step 644, the audit subsystem 170 records corpus formation, deployment-artifact generation, localized model-package generation, deployment-package generation, and execution-context verification events, including the requesting actor, selected and excluded assets, evaluated decision conditions, selected response modes, execution context identifiers, and time values.

At step 646, the system enforces post-generation controls, including controlling export, disclosure, reuse, or deployment of generated corpus objects, retrieval bindings 654, deployment artifacts 656, localized model packages 658, or deployment packages 660 based on decision conditions and response policies.

At step 648, upon completion or termination of the operation, the execution-context and isolation-verification subsystem 190 performs a cleanup operation and generates a cleanup-completion event recorded by the audit subsystem 170.

### REFERENCE LIST

100 – GOVERNED MEMORY-USE CONTROL SYSTEM
104 – PROCESSOR
106 – NON-TRANSITORY MEMORY DEVICE
108 – PERSISTENT STORAGE DEVICE
110 – NETWORK INTERFACE
114 – ORGANIZATION-CONTROLLED EXECUTION ENVIRONMENT
130 – GOVERNED MEMORY STORE
132 – SEARCHABLE MEMORY INDEX
134 – GOVERNED MEMORY ASSET RECORDS
140 – MEMORY-USE INTERFACE
142 – REQUEST REPRESENTATION SUBSYSTEM
150 – MEMORY-USE DECISION ENGINE
160 – RESPONSE POLICY AND EXECUTION CONTROL SUBSYSTEM
170 – AUDIT SUBSYSTEM
190 – EXECUTION-CONTEXT AND ISOLATION-VERIFICATION SUBSYSTEM
196 – CORPUS AND DEPLOYMENT ARTIFACT SUBSYSTEM
620 – EXECUTION CONTEXT, CORPUS FORMATION, AND DEPLOYMENT ARTIFACTS PROCESS
622 – REQUEST RECEIPT STEP
624 – EXECUTION CONTEXT ASSIGNMENT STEP
626 – RESOURCE FINGERPRINT GENERATION STEP
628 – ISOLATION POLICY EVALUATION STEP
630 – CANDIDATE ASSET IDENTIFICATION STEP
632 – DECISION CONDITION EVALUATION STEP
634 – RESPONSE MODE ENFORCEMENT STEP
636 – CORPUS FORMATION STEP
638 – EVALUATION CORPUS OR RETRIEVAL BINDING GENERATION STEP
640 – DEPLOYMENT ARTIFACT GENERATION STEP
642 – LINEAGE ASSOCIATION STEP
644 – AUDIT RECORDING STEP
646 – POST-GENERATION CONTROL STEP
648 – CLEANUP AND COMPLETION RECORDING STEP
650 – FROZEN CORPUS SNAPSHOT
652 – EVALUATION CORPUS
654 – RETRIEVAL BINDING
656 – DEPLOYMENT ARTIFACT
658 – LOCALIZED MODEL PACKAGE
660 – DEPLOYMENT PACKAGE

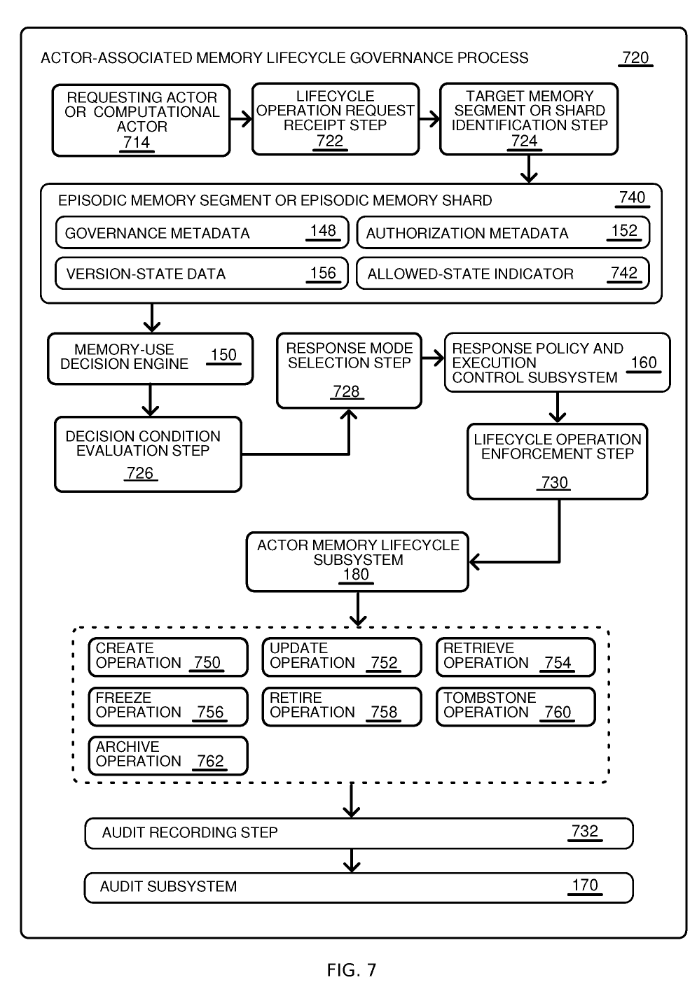

FIG. 7 - Actor-Associated Memory Lifecycle Governance

FIG. 7 illustrates an actor-associated memory lifecycle governance process 720 performed by the actor memory lifecycle subsystem 180 together with the memory-use decision engine 150, the response policy and execution control subsystem 160, and the audit subsystem 170. The process 720 governs lifecycle operations involving actor-associated memory, including episodic memory segments or episodic memory shards 740 associated with a requesting actor or a computational actor 714.

The process 720 begins at step 722, where the system receives, from or on behalf of a requesting actor or computational actor 714, a lifecycle operation request involving actor-associated memory. The requested lifecycle operation may comprise a create operation 750, update operation 752, retrieve operation 754, freeze operation 756, retire operation 758, tombstone operation 760, archive operation 762, or another permitted lifecycle transition associated with an episodic memory segment or episodic memory shard 740.

At step 724, the system identifies the target episodic memory segment or episodic memory shard 740 and retrieves associated governance metadata 148, authorization metadata 152, version-state data 156, and an allowed-state indicator 742 identifying which lifecycle operations are permitted for the target actor-associated memory object.

At step 726, the memory-use decision engine 150 evaluates a memory-use decision condition for the requested lifecycle operation. The evaluated decision condition may include a semantic-support condition, a provenance-validation condition, an authorization condition, and a memory-validity condition, and may further incorporate one or more risk, isolation, or policy-conflict conditions when applicable.

At step 728, the response policy and execution control subsystem 160 selects a response mode for the requested lifecycle operation. The selected response mode may permit the operation, limit the operation, suppress the operation, deny the operation, or route the operation for review based on the evaluated decision conditions and applicable policy rules.

At step 730, the system enforces the selected response mode with respect to the actor-associated memory. When permitted, the system performs the requested lifecycle operation on the episodic memory segment or episodic memory shard 740, including one or more of the create operation 750, update operation 752, retrieve operation 754, freeze operation 756, retire operation 758, tombstone operation 760, or archive operation 762. When limited or denied, the system restricts, prevents, or defers the requested lifecycle operation in accordance with the selected response mode.

At step 732, the audit subsystem 170 records an audit event record or decision-basis record corresponding to the requested lifecycle operation, including the requesting actor or computational actor 714, the target episodic memory segment or episodic memory shard 740, the evaluated decision conditions, the selected response mode, and the resulting lifecycle action or restriction.

### REFERENCE LIST

148 – GOVERNANCE METADATA
152 – AUTHORIZATION METADATA
156 – VERSION-STATE DATA
150 – MEMORY-USE DECISION ENGINE
160 – RESPONSE POLICY AND EXECUTION CONTROL SUBSYSTEM
170 – AUDIT SUBSYSTEM
180 – ACTOR MEMORY LIFECYCLE SUBSYSTEM
714 – REQUESTING ACTOR OR COMPUTATIONAL ACTOR
720 – ACTOR-ASSOCIATED MEMORY LIFECYCLE GOVERNANCE PROCESS
722 – LIFECYCLE OPERATION REQUEST RECEIPT STEP
724 – TARGET MEMORY SEGMENT OR SHARD IDENTIFICATION STEP
726 – DECISION CONDITION EVALUATION STEP
728 – RESPONSE MODE SELECTION STEP
730 – LIFECYCLE OPERATION ENFORCEMENT STEP
732 – AUDIT RECORDING STEP
740 – EPISODIC MEMORY SEGMENT OR EPISODIC MEMORY SHARD
742 – ALLOWED-STATE INDICATOR
750 – CREATE OPERATION
752 – UPDATE OPERATION
754 – RETRIEVE OPERATION
756 – FREEZE OPERATION
758 – RETIRE OPERATION
760 – TOMBSTONE OPERATION
762 – ARCHIVE OPERATION

1. A governed memory-use control system for a regulated computing environment, including a regulated artificial intelligence environment, comprising:
one or more processors;
one or more non-transitory memory devices storing instructions executable by the one or more processors;
a governed memory store configured to store governed memory asset records; a searchable memory index operatively coupled to the governed memory store; a memory-use decision engine; a response policy and execution control subsystem; and an audit subsystem;
wherein the one or more processors, by executing the instructions, are configured to: receive, through an authenticated communication channel, a protected source record associated with an organization; process the protected source record into one or more memory units; generate, within an organization-controlled execution environment, one or more semantic representations corresponding to the one or more memory units; create, for at least one of the one or more memory units, a governed memory asset record comprising or being associated with: a memory-unit identifier, at least one semantic representation, provenance linkage, governance metadata, authorization metadata, representation-version metadata, and version-state data indicating a memory-validity status; store the governed memory asset record in the governed memory store; receive, from a requesting actor, a memory-use request associated with a requested operation; generate or receive a request representation corresponding to the memory-use request; identify, using the searchable memory index and based at least in part on the request representation, one or more candidate governed memory assets, wherein identification of a candidate governed memory asset does not itself authorize use of the candidate governed memory asset; evaluate, for at least one candidate governed memory asset, a memory-use decision condition comprising: a semantic-support condition based on a relationship between the request representation and a semantic representation associated with the candidate governed memory asset, a provenance-validation condition based on the provenance linkage associated with the candidate governed memory asset, an authorization condition based on authorization data associated with the requesting actor and the governance metadata associated with the candidate governed memory asset, and a memory-validity condition based on the version-state data associated with the candidate governed memory asset; select, according to a response policy and based on the memory-use decision condition, a response mode for the requested operation; enforce the selected response mode before the candidate governed memory asset is permitted to affect the requested operation, wherein enforcing the selected response mode comprises permitting, limiting, suppressing, denying, redacting, preventing writing, controlling export or disclosure, or routing for review; and
generate, by the audit subsystem, a structured decision-basis record stored in a tamper-evident audit structure, the structured decision-basis record identifying at least the memory-use request, the selected response mode, and a basis for the selected response mode.

2. The governed memory-use control system of claim 1, wherein the governed memory asset records comprise actor-associated memory including one or more episodic memory segments or episodic memory shards associated with a requesting actor or a computational actor, and wherein the one or more processors are further configured to associate, with at least one episodic memory segment or episodic memory shard, governance metadata, authorization metadata, version-state data, and an allowed-state indicator identifying permitted lifecycle operations for the episodic memory segment or episodic memory shard.

3. The governed memory-use control system of claim 1, wherein the one or more semantic representations comprise at least one of a dense vector representation, a sparse vector representation, a graph representation, a symbolic representation, a multimodal representation, a hybrid search representation, or an indexed representation generated from text, structured data, image data, signal data, event data, or combinations thereof.

4. The governed memory-use control system of claim 1, wherein the requested operation comprises at least one of retrieval, output generation, summarization, transformation, redaction, memory writing, memory updating, disclosure, export, derived-artifact generation, corpus formation, evaluation-record generation, retrieval-binding generation, deployment-artifact generation, or localized model-package generation.

5. The governed memory-use control system of claim 1, wherein the response mode is selected from a plurality of response modes comprising plaintext return, protected-content return, redacted return, metadata-only return, summary-only return, citation-limited return, derived-output return, output suppression, operation denial, memory-write prevention, export control, disclosure control, delayed release after secondary approval, and human-review routing.

6. The governed memory-use control system of claim 1, wherein the version-state data indicates that the corresponding governed memory asset record has a memory-validity status selected from active, conditionally active, frozen, superseded, excluded from active use, forensic-only, archived, tombstoned, retired, or pending review, and wherein the memory-validity condition prevents or limits use of the corresponding governed memory asset record when the memory-validity status is not eligible for the requested operation.

7. The governed memory-use control system of claim 1, wherein the tamper-evident audit structure comprises at least one of an append-only event store, a hash-linked event chain, a Merkle-linked event structure, a digitally signed audit record set, a write-once storage structure, an externally anchored audit digest, or an immutable object store, and wherein the structured decision-basis record further identifies at least one of a candidate asset identifier, a policy identifier, a provenance-validation result, an authorization result, a memory-validity result, a semantic-support value, a selected response mode, an enforcement action, or a denial reason code.

8. The governed memory-use control system of claim 2, wherein the one or more processors are further configured to receive a lifecycle operation request involving the actor-associated memory, evaluate the memory-use decision condition for the lifecycle operation request, select the response mode for the lifecycle operation request, enforce the response mode to permit, limit, suppress, deny, freeze, retire, tombstone, archive, or route for review the lifecycle operation, and record an audit event record or decision-basis record corresponding to the lifecycle operation.

9. A computer-implemented method for controlling use of governed memory assets in a regulated computing environment, including a regulated artificial intelligence environment, the method comprising:
receiving, by one or more processors, a memory-use request from a requesting actor;
generating or receiving, by the one or more processors, a request representation corresponding to the memory-use request;
identifying, by the one or more processors and using a searchable memory index, one or more candidate governed memory assets stored in a governed memory store, wherein identification of a candidate governed memory asset does not itself authorize use of the candidate governed memory asset;
evaluating, by the one or more processors and for at least one candidate governed memory asset, a memory-use decision condition comprising:
a semantic-support condition based on a relationship between the request representation and a semantic representation associated with the candidate governed memory asset,
a provenance-validation condition based on provenance linkage associated with the candidate governed memory asset,
an authorization condition based on authorization data associated with the requesting actor and governance metadata associated with the candidate governed memory asset, and
a memory-validity condition based on version-state data associated with the candidate governed memory asset;
selecting, by the one or more processors and according to a response policy, a response mode based on the memory-use decision condition;
enforcing, by the one or more processors, the selected response mode before the candidate governed memory asset is permitted to influence a requested operation associated with the memory-use request, wherein enforcing the selected response mode comprises controlling whether the candidate governed memory asset is permitted to influence retrieval, output generation, memory writing, derived-artifact generation, corpus formation, retrieval-binding generation, deployment-artifact generation, or localized model-package generation; and
recording, by the one or more processors, a structured decision-basis record in a tamper-evident audit structure.

10. The computer-implemented method of claim 9, wherein evaluating the memory-use decision condition comprises computing a semantic-support value between the request representation and the semantic representation associated with the candidate governed memory asset, comparing the semantic-support value to a defined threshold, and preventing the candidate governed memory asset from influencing the requested operation when the semantic-support value fails to satisfy the defined threshold.

11. The computer-implemented method of claim 9, wherein evaluating the memory-use decision condition further comprises validating that the provenance linkage associated with the candidate governed memory asset identifies at least one protected source record, ingestion event, prior governed memory asset, derived artifact, corpus snapshot, or authorized source state satisfying a defined provenance-validity requirement.

12. The computer-implemented method of claim 9, wherein enforcing the selected response mode comprises selecting, based on failure of at least one of the provenance-validation condition, the authorization condition, or the memory-validity condition, at least one of metadata-only return, redacted return, citation-limited return, output suppression, operation denial, memory-write prevention, export control, disclosure control, or human-review routing.

13. The computer-implemented method of claim 9, wherein the requested operation comprises generating an output, summary, response object, agent action, memory update, derived artifact, corpus entry, retrieval binding, deployment artifact, or localized model package, and wherein enforcing the selected response mode prevents the candidate governed memory asset from influencing the requested operation unless the memory-use decision condition is satisfied.

14. The computer-implemented method of claim 9, wherein recording the structured decision-basis record comprises storing, in the tamper-evident audit structure, at least one identifier associated with a requesting actor, requested operation, candidate governed memory asset, policy, or response policy, and at least one condition evaluation result, selected response mode, time value, semantic-support value, enforcement action, or decision reason.

15. The computer-implemented method of claim 9, further comprising verifying an execution context assigned to the requested operation by generating a resource fingerprint for the execution context, comparing the resource fingerprint to an isolation policy, and preventing, limiting, reassigning, suppressing, or routing for review the requested operation when the resource fingerprint fails to satisfy the isolation policy.

16. A computer-implemented method for generating a governed downstream artifact in a regulated computing environment, including a regulated artificial intelligence environment, the method comprising:
identifying, by one or more processors and from a governed memory store, candidate governed memory assets for a downstream artifact-generation operation;
evaluating, by the one or more processors and for at least one candidate governed memory asset, a memory-use decision condition comprising at least:
a semantic-support condition, a provenance-validation condition, an authorization condition, and a memory-validity condition;
determining, by the one or more processors and based on the memory-use decision condition, whether the at least one candidate governed memory asset is permitted to influence a corpus formation operation, a retrieval-binding generation operation, a deployment-artifact generation operation, or a localized model-package generation operation;
forming, by the one or more processors and using governed memory assets permitted by the memory-use decision condition, at least one governed downstream artifact selected from:
a frozen corpus snapshot, an evaluation corpus, a retrieval binding, a deployment artifact, and a localized model package;
associating lineage information with the governed downstream artifact, the lineage information identifying one or more source governed memory assets; and
recording, by the one or more processors, a decision-basis record or audit event record corresponding to the downstream artifact-generation operation.

17. The computer-implemented method of claim 16, wherein forming the governed downstream artifact comprises generating a frozen corpus snapshot that is write-locked and associated with a snapshot identifier, an asset inclusion list identifying governed memory assets permitted by the memory-use decision condition, and an asset exclusion list identifying governed memory assets not permitted by the memory-use decision condition.

18. The computer-implemented method of claim 16, wherein associating lineage information comprises generating a lineage record or lineage graph linking the governed downstream artifact to one or more source governed memory assets, including at least one of a memory-unit identifier, provenance linkage, governance metadata, representation-version metadata, policy identifier, transformation identifier, requesting-actor identifier, or time value.

19. The computer-implemented method of claim 16, wherein forming the governed downstream artifact further comprises assigning governance metadata and version-state data to the governed downstream artifact, the governance metadata being inherited from or computed based on governance metadata of the source governed memory assets, and wherein subsequent use of the governed downstream artifact is subject to evaluation of a memory-use decision condition.

20. The computer-implemented method of claim 16, further comprising controlling export or disclosure of the governed downstream artifact by enforcing a response mode that prevents or limits export, disclosure, reuse, or deployment of the governed downstream artifact unless the memory-use decision condition and an applicable response policy are satisfied, and recording an audit event corresponding to such control.

21. A computer-implemented governed memory-use control system configured to control influence of stored data on computational operations within a regulated computing environment, comprising:
one or more processors; and one or more non-transitory memory devices storing instructions that, when executed by the one or more processors, cause the system to:
(a) form governed memory assets by receiving, via an authenticated communication channel, a protected source record;
transforming the protected source record into one or more memory units; and,
generating, within an organization-controlled execution environment, at least one machine-generated semantic representation corresponding to each memory unit;
(b) store, in a governed memory store operatively coupled to a searchable memory index, a governed memory asset record for at least one memory unit, the governed memory asset record comprising:
a memory-unit identifier,
the semantic representation,
machine-readable provenance linkage to at least one source record or prior artifact,
governance metadata specifying usage constraints,
authorization metadata,
and version-state data indicating a memory-validity status;
(c) receive a memory-use request corresponding to a requested computational operation and generate a request representation corresponding thereto;
(d) identify, using the searchable memory index and based on the request representation, one or more candidate governed memory assets, wherein identification of a candidate governed memory asset is explicitly decoupled from authorization to influence the requested computational operation;
(e) prior to permitting any candidate governed memory asset to influence the requested computational operation, execute a machine-enforced decision evaluation pipeline comprising:
computing a semantic-support value between the request representation and the semantic representation of the candidate governed memory asset and evaluating a semantic-support condition;
validating the provenance linkage against a defined provenance-validity requirement to evaluate a provenance-validation condition;
evaluating an authorization condition by comparing actor-specific authorization data with the governance metadata and authorization metadata; and
evaluating a memory-validity condition based on the version-state data;
(f) generate, based on the decision evaluation pipeline, a decision result that determines whether and to what extent the candidate governed memory asset is permitted to computationally influence the requested operation;
(g) select, using a response policy, a response mode that specifies an execution constraint governing how the candidate governed memory asset is permitted to affect the requested computational operation, the response mode comprising at least one of: permitting, restricting, redacting, metadata-only use, summary-only use, citation-limited use, preventing write operations, suppressing influence, denying the operation, or routing for review;
(h) enforce, at runtime and prior to execution of the requested computational operation, the selected response mode by controlling whether and how the candidate governed memory asset is allowed to contribute to:
output generation,
memory modification,
derived artifact generation,
corpus formation, or
deployment artifact generation,
such that the candidate governed memory asset is prevented from influencing the requested computational operation unless the evaluated decision conditions satisfy the response policy;
(i) apply asset-specific enforcement such that different candidate governed memory assets associated with the same memory-use request are subjected to different response modes; and,
(j) generate and store, in a tamper-evident audit structure, a structured decision-basis record comprising:
the memory-use request,
at least one evaluated decision condition,
the decision result,
the selected response mode, and
an enforcement action,
wherein the structured decision-basis record enables reconstruction of how the candidate governed memory asset was permitted or prevented from influencing the requested computational operation.
